(19) United States
(12) Patent Application Publication
(10) Pub. No.: US 2022/0223319 A1
(43) Pub. Date: Jul. 14, 2022

(54) TWISTED PAIR COMMUNICATION CABLES WITH ADDITIONAL CONDUCTIVE WIRES

(71) Applicant: Superior Essex International LP, Atlanta, GA (US)

(72) Inventors: Christopher W. McNutt, Woodstock, GA (US); Amir Sekhavat, Marietta, GA (US); Anthony Szot, Great Bend, KS (US); Brad R. Johnson, Woodstock, GA (US)

(73) Assignee: Superior Essex International LP, Atlanta, GA (US)

(21) Appl. No.: 17/327,201

(22) Filed: May 21, 2021

Related U.S. Application Data
(63) Continuation-in-part of application No. 17/147,000, filed on Jan. 12, 2021.

(51) Int. Cl. H01B 7/22; H01B 11/02; H01B 1/02; H01B 3/30

(52) U.S. Cl. CPC H01B 7/22; H01B 3/30; H01B 1/02; H01B 11/02

(57) ABSTRACT

A twisted pair cable may include a plurality of twisted pairs of individually insulated wires and at least one additional wire. Each additional wire may include a conductor and at least one layer of enamel insulation material or insulation formed from a thermoset material formed around the conductor. A jacket may be formed around the four twisted pairs and the at least one additional wire.

### CROSS-REFERENCE TO RELATED APPLICATION

The present application is a continuation-in-part of U.S. patent application Ser. No. 17/147,000 filed on Jan. 12, 2021 and entitled “Twisted Pair Communication Cables with Integrated Pulling Elements”, which is incorporated by reference herein in its entirety.

### TECHNICAL FIELD

Embodiments of the disclosure relate generally to communication cables and, more particularly, to twisted pair communication cables incorporating magnet wires or other additional conductive wires.

### BACKGROUND

A wide variety of different types of communication cables are utilized to transmit information. For example, twisted pair communication cables are utilized to transmit Ethernet and other data signals in accordance with one or more suitable Category cabling standards. In certain applications, twisted pair cables are utilized to provide both data signals and electrical power to a wide variety of devices, such as lighting devices, wireless access points, etc. Typically, electrical power is provided over twisted pairs in accordance with a Power over Ethernet (“PoE”) standard.

Regardless of the intended application, industry standards limit installation lengths of twisted pair cables to 100 m. However, recent customer expectations have led to an increased desire to install PoE and Category cables at continuous lengths exceeding the industry requirement of 100 m. Twisted pair cables have been sold that are capable of adequately transmitting signal and power at distances greater than 100 m for many years. Notwithstanding this fact, there is an opportunity in the industry for improved twisted pair cables that incorporate one or more additional wires or conductors. These additional wires can be utilized for a wide variety of suitable purposes including, but not limited to, transmission of data signals, transmission of a power signal, transmission of toning or test signals, heat dissipation, and/or providing additional tensile strength to the cable. In certain embodiments, one or more additional wires may be incorporated into a cable in order to clearly move the cable outside of the scope of certain patents within the cabling industry that require a twisted pair cable to include four twisted pairs of wires and no other wires, notwithstanding the invalidity arguments that can be applied against such patents.

In other embodiments, one or more additional wires may be utilized to permit cables to withstand greater pulling forces. Conventional cables have not been designed to mechanically endure an installation process that exceeds lengths of 100 m. As a result, conventional twisted pair cable designs may be subject to permanent and irreversible stretching of the twisted pairs in the event that they are installed at lengths over 100 m. Current twisted pair cabling standards require a maximum pulling force exerted on a cable to not exceed 110 N. For example, the ANSI/TIA 568.2-D standard published by the American National Standards Institute (“ANSI”) in 2018 specifies that a maximum pulling tension for a four twisted pair 100 m cable should not exceed 110 N (or 25 lbf) to avoid stretching the copper pairs during cable installation. Similarly, the Insulated Cable Engineers Association ICEA S-90-661 standard, published by ANSI on Jun. 22, 2012, includes a requirement for a maximum pulling force to not exceed 27 N/pair. In a standard four pair cable, the pulling force cannot exceed 108 N to ensure that the twisted pairs are not stretched during installation. Stretching the twisted pairs during installation, for example, by applying pulling forces to the cable, may damage the conductors and/or negatively impact the electrical performance of the cable.

With extended installation lengths, such as installation lengths over 100 m, longer and heavier cables must be pulled by technicians. As a result, it may be necessary to pull a cable with a force exceeding the 110 N permitted by existing standards. Accordingly, in certain embodiments, there is an opportunity for improved twisted pair cables that can withstand higher pulling forces. In particular, there is an opportunity for improved twisted pair cables with integrating pulling elements that withstand higher pulling forces and facilitate potential installation at extended distances.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1-8 are cross-sectional views of example twisted pair cables with integrated additional wires, according to an illustrative embodiment of the disclosure.

FIG. 9 is a flowchart of an example method for installing a twisted pair communication cable that includes an integrated pulling element as an additional wire, in accordance with an embodiment of the disclosure.

### DETAILED DESCRIPTION

Various embodiments of the present disclosure are directed to twisted pair cables that include one or more additional conductive wires. In certain embodiments, the one or more additional wires may be formed as or may include one or more magnet wires. A magnet wire or winding wire may include a central conductor insulated with one or more polymeric enamel layers formed from one or more thermoset materials. A wide variety of suitable thermoset materials and/or combinations of thermoset materials may be utilized as desired to form one or more enamel insulation layers including, but not limited to, polyimide, polyamideimide, polyester, polyamide, amideimide, polyesterimide, polysulfone, polyphenylenesulfone, polysulfide, polyphenylenesulfide, or polyetherimide. Thermoset materials cannot be extruded in order to form insulation as the materials will irreversible cure and harden as they are heated in an extrusion device. Instead, thermoset polymeric materials are typically combined with solvents in a varnish that is applied to a wire (e.g., directly on the conductor, on an underlying insulation layer, etc.). The varnish is then cured in an oven or via other suitable curing devices. During the curing process, the solvents are evaporated and a solid polymeric insulation layer is formed. This process is repeated to form additional enamel layers until a desired overall insulation thickness is achieved. While magnet wires are typically intended for use in motors, transformers, and/or other electrical devices, the present disclosure contemplates the novel incorporation of magnet wire as an additional wire in a twisted pair communications cable.

In other embodiments, the additional wire(s) may be formed as one or more integrated pulling elements. The pulling elements may allow the twisted pair cables to withstand greater pulling forces than those permitted by existing cabling standards. For example, the pulling elements may allow the cables to withstand pulling forces greater than 110 Newtons, such as pulling forces of 330 N or greater. As a result, the cables may be easily pulled and installed at longitudinal lengths or distances greater than 100 m without the twisted pairs being stretched or elongated. Twisted pair cables with integrated pulling elements may be utilized in a wide variety of suitable applications, such as Category cabling applications, Power over Ethernet (“PoE”) applications, etc.

In one example embodiment, a cable may include a plurality of twisted pairs of individually insulated conductors. Any suitable number of pairs may be utilized, such as four pairs of conductors. Additionally, the conductors incorporated into the pairs may be formed with a wide variety of suitable diameters, gauges, and/or other dimensions. The various pairs may also be twisted with any suitable respective twist lays associated with a desired application. In accordance with an aspect of the disclosure, the cable may also include one or more additional wires. In certain embodiments, the additional wire(s) may include one or more magnet wires, and each magnet wire may include a conductor and enamel insulation formed around the conductor. In other embodiments, the additional wire(s) may include one or more pulling elements that permit the cable to withstand greater pulling forces without elongating or stretching the pairs. For example, integration of one or more pulling elements may permit the cable to withstand a pulling force of 330 N with an elongation of less than 0.20 percent. A jacket may then be formed around the plurality of twisted pairs and the pulling element.

In the event that a cable includes one or more pulling elements, a wide variety of suitable pulling elements may be incorporated into the cable as desired in various embodiments. These pulling elements may be formed from a wide variety of suitable materials and/or with a wide variety of suitable dimensions. In certain embodiments, a metallic pulling element may be utilized such that the pulling element constitutes an additional wire. For example, the pulling element may be formed from steel, titanium, another suitable metal, or a metallic alloy. In other embodiments, the pulling element may be formed from other suitable materials, such as dielectric materials (e.g., glass reinforced plastic, aramid, etc.) and/or semi-conductive materials (e.g., carbon fiber, etc.). In certain embodiments, a pulling element (e.g., a metallic pulling element, etc.) may be formed from a material (e.g., a metallic material, etc.) having a higher elastic modulus than that of the copper or other conductive material utilized in the twisted pairs. For example, a pulling element may be formed from a material having an elastic modulus greater than 125 GPa. In this regard, the pulling element may primarily bear the tensile load associated with pulling the cable.

An additional wire (e.g., a magnet wire, a pulling element, etc.) may be formed with a wide variety of suitable dimensions, such as any suitable gauge or cross-sectional area. In certain embodiments, a magnet wire utilized as an additional wire may be sufficiently sized such that it can be adequately processed and incorporated into a cable during cable assembly. For example, a magnet wire may be approximately 35 AWG or larger, or may have a cross-sectional area of approximately 0.0160 mm² or larger. In other embodiments, a pulling element may be sized in order to allow the cable to withstand a desired pulling force. For example, a pulling element may have a cross-sectional area of at least 0.115 mm². For example, a 26 AWG or larger steel pulling element may be utilized. Additionally, in certain embodiments, an additional wire may be formed from a single component. In other embodiments, an additional wire may be formed from a plurality of components that are stranded or twisted together. For example, an additional wire may be formed with a single conductor or with a plurality of conductive strands. Additionally, in certain embodiments, a bare, uninsulated, or uncoated additional wire may be utilized. In other embodiments, suitable insulation or a suitable coating may be formed on an additional wire.

Any number of suitable additional wires (e.g., magnet wires, pulling elements, etc.) may be incorporated into a cable as desired in various embodiments. In certain embodiments, a single additional wire may be utilized. In other embodiments, a plurality (e.g., two, three, four, etc.) of additional wires may be incorporated into a cable. In certain embodiments, a plurality of additional wires may have similar constructions. In other embodiments, at least two additional wires may be formed with different materials and/or different dimensions. Additionally, one or more additional wires may be positioned at a wide variety of suitable locations within a cable. For example, one or more additional wires may be positioned between the twisted pairs and the cable jacket (e.g., around an outer periphery of the twisted pairs, etc.). As another example, an additional wire may be positioned between the plurality of twisted pairs. As yet another example, one or more additional wires may be embedded within the cable jacket. In other embodiments, a plurality of additional wires may be positioned at different locations. For example, a first additional wire may be positioned between the plurality of twisted pairs while a second additional wire is positioned outside an outer periphery of the twisted pairs. Regardless of the positioning of one or more additional wires, in certain embodiments, an additional wire may extend in a longitudinal direction parallel to the plurality of the twisted pairs. In other words, the additional wire may not be twisted or stranded with the twisted pairs. In other embodiments, an additional wire such as a magnet wire may be twisted or otherwise stranded with the plurality of twisted pairs.

A wide variety of benefits may be attained by incorporating one or more additional wires into a twisted pair cable. For example, an additional wire may be utilized to transmit a data and/or power signal, to provide a toning element, to dissipate heat within a cable, or to provide additional tensile strength. As a result of incorporating one or more pulling elements in certain embodiments, a greater pulling force may be applied or imparted onto the cable without stretching, elongating, or damaging the twisted pairs. The ability to pull a twisted pair cable with greater force may facilitate easier installation of cable runs at lengths exceeding the 100 m limit established by industry standards. For example, a four pair cable that can withstand a pulling force of 330 N may be installed at lengths up to approximately 300 m. Additionally, in certain embodiments, one or more additional wires may be incorporated into a twisted pair cable without materially altering an outside diameter of the twisted pair cable. For example, a twisted pair cable incorporating one or more additional wires may have an outside diameter less than or equal to approximately 10 mm.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

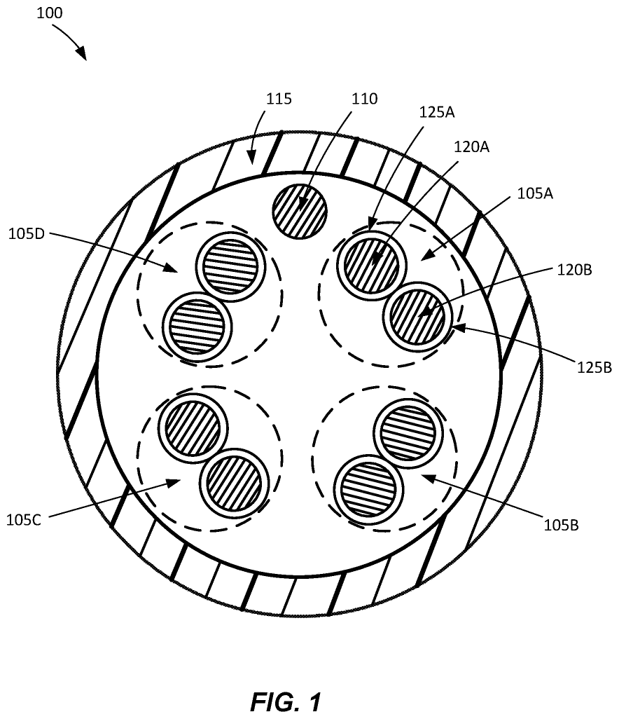

FIGS. 1-8 illustrate a few examples of twisted pair communication cables that incorporate or include one or more additional wires. As illustrated, the example cables include a wide variety of suitable constructions with different components, such as twisted pairs, separators, shielding elements, etc. Additionally, each cable may incorporate any number of suitable additional wires, and the additional wires may have a wide variety of suitable constructions, dimensions, positions, and/or orientations. The cable components and additional wire configurations illustrated in any of the cables of FIGS. 1-8 may be combined in any suitable manner in other embodiments of the disclosure. Indeed, the cables illustrated in FIGS. 1-8 are provided by way of non-limiting example only.

The example cables of FIGS. 1-8 may be suitable for use in a wide variety of applications including, but not limited to, indoor, outdoor, plenum, and/or riser applications. In certain embodiments, the cables may be suitable for use in Category cabling applications, such as Category 5, Category 5e, Category 6, Category 6A, or Category 8 applications. In other embodiments, the cables may be suitable for use in Power over Ethernet (“PoE”) applications. In other embodiments, a cable may be suitable for use in both a PoE and a Category cabling application. An intended application for a cable may be defined by one or more suitable industry standards, such as the ANSI/TIA 568.2-D standard or an Institute for Electrical and Electronic Engineers (“IEEE”) Power over Ethernet Standard (e.g., IEEE 802.3af, IEEE 802.3at, IEEE 802.3bt, etc.). Certain aspects of a cable, such as conductor sizes and/or twist lays of the twisted pairs may be engineered such that the cable can satisfy performance requirements associated with one or more applicable industry standards.

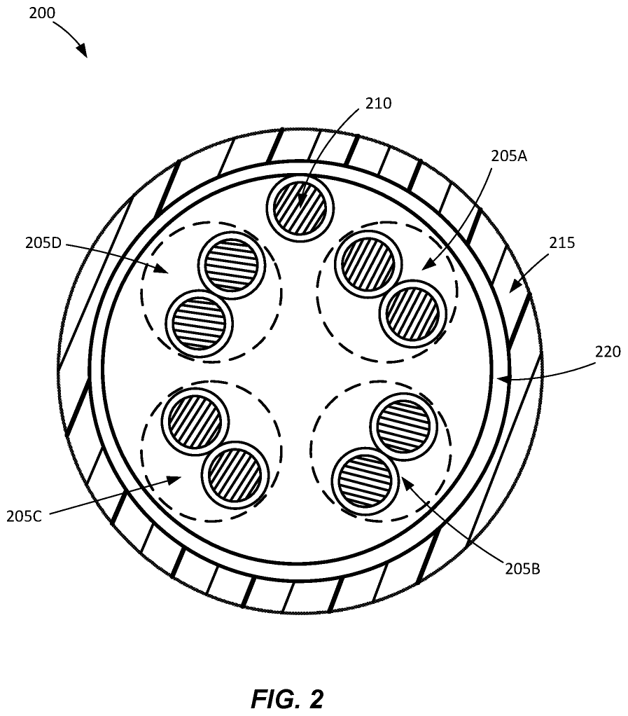

Turning first to FIG. 1, a cross-section of a first example cable 100 with an additional wire is illustrated. As shown in FIG. 1, the cable 100 may include a plurality of twisted pairs 105A-D of individually insulated conductors, at least one additional wire 110, and a jacket 115 formed around the twisted pairs 105A-D and the additional wire 110. A wide variety of other components may optionally be incorporated into the cable 100 as desired in various embodiments, such as a separator, one or more shielding elements, one or more rip cords, one or more drain wires, etc. Certain optional components that may be incorporated into the cable 100 are described in greater detail below and illustrated with reference to other example cables included in FIGS. 2-8. Each of the components of the cable 100 will now be described in greater detail.

According to an aspect of the disclosure, the cable 100 may include a plurality of twisted pairs of individually insulated conductors. As shown in FIG. 1, the cable 100 may include four twisted pairs 105A, 105B, 105C, 105D; however, any other suitable number of pairs may be utilized in other embodiments. Each twisted pair (referred to generally as twisted pair 105) may include two electrical conductors 120A, 120B, each covered with respective insulation 125A, 125B. The electrical conductors (generally referred to as conductor 120) of a twisted pair 105 may be formed from any suitable electrically conductive material, such as copper, aluminum, silver, annealed copper, gold, a conductive alloy, etc. Additionally, the electrical conductors 120 may have any suitable diameter, gauge, and/or other dimensions. Further, each of the electrical conductors 120 may be formed as either a solid conductor or as a conductor that includes a plurality of conductive strands that are twisted together.

In certain embodiments, the cable 100 may include only four twisted pairs of individually insulated conductors 105A-D, one or more additional wires 110 (e.g., one or more magnet wires, one or more pulling elements, etc.), and no other conductive elements and/or transmission media. For example, the cable 100 may include four pairs 105A-D, one or more additional magnet wires and/or pulling elements 110, and no other conductive components that are suitable for transmitting communications and/or power signals. As another example, the cable 100 may include four pairs 105A-D, one or more additional magnet wires and/or pulling elements 110, one or more drain wires, and no other conductive components that are suitable for transmitting communications and/or power signals. As another example, the cable 100 may include four pairs 105A-D, one or more additional magnet wires and/or pulling elements 110, and no other components (e.g., conductive components, optical fibers, etc.) that are suitable for transmitting communications and/or power signals. As yet another example, the cable 100 may include four pairs 105A-D, one or more additional magnet wires and/or pulling elements 110, one or more drain wires, and no other components (e.g., conductive components, optical fibers, etc.) that are suitable for transmitting communications and/or power signals.

In certain embodiments, the electrical conductors 120 of the twisted pairs 105A-D may be sized in accordance with a desired application for the cable 100. For example, in typical Category cabling, the electrical conductors 120 may be 23 American Wire Gauge (“AWG”) or 24 AWG conductors. Each twisted pair 105 can carry data or some other form of information, for example in a range of about one to ten Giga bits per second (“Gbps”) or other suitable data rates, whether higher or lower. In certain embodiments, each twisted pair 105 supports data transmission of about two and one-half Gbps (e.g. nominally two and one-half Gbps), with the cable 100 supporting about ten Gbps (e.g. nominally ten Gbps). In certain embodiments, each twisted pair 105 supports data transmission of up to about ten Gbps (e.g. nominally ten Gbps), with the cable 100 supporting about forty Gbps (e.g. nominally forty Gbps).

As desired, larger conductors may be utilized in association with PoE applications in order to satisfy desirable power transmission requirements. For example, the electrical conductors 120 may be 22 AWG, 21 AWG, or 20 AWG conductors in PoE applications. In certain embodiments in which the cable 100 is suitable for use in PoE applications, the electrical conductors 120 of certain twisted pairs (e.g., illustrated twisted pairs 105A-D, etc.) may have a diameter and/or cross-sectional area that is greater than or equal to required minimum dimensions for 22 AWG conductors. For example, electrical conductors 120 may have a diameter that is greater than or equal to approximately 0.0240 inches (0.6096 mm). In various embodiments, electrical conductors 120 may have diameters that are greater than or equal to approximately 0.0240, 0250, 0.0255, 0.0260, 0.0275, 0.0280, 0.0285, 0.0300, 0.0310, 0.0320, or 0.0340 inches, or diameters incorporated in a range between any two of the above values.

Additionally, the electrical conductors 120 and/or certain twisted pairs may be capable of transmitting a desired power signal for PoE applications. For example, a desired number of twisted pairs (e.g., the illustrated four twisted pairs 105A-D, etc.) may be capable of transmitting at least approximately 100 Watts of power at approximately 1.0 ampere per pair over a distance of approximately 100 meters with at least approximately 88% efficiency at a temperature of approximately twenty degrees Celsius (20° C.). In certain embodiments, each example twisted pair 105 may be capable of transmitting a desired portion of the overall power. For example, each set of two twisted pairs (e.g., twisted pairs 105A-B and 105C-D, etc.) may be capable of transmitting at least approximately 50 Watts of power. The power transmitted by each set of twisted pairs may be equal to the current carried by each twisted pair multiplied by the voltage between the two twisted pairs. The current and/or voltage on/between each twisted pair may be adjusted as desired in order to attain a desired power signal. As one example, each conductor of a twisted pair 105 may carry an approximately 0.5 ampere signal. Thus, a combined signal of approximately 1.0 ampere may be transmitted on a twisted pair. Other suitable power transmission requirements may be utilized as desired in other embodiments.

The twisted pair insulation (generally referred to as insulation 125) may include any suitable dielectric materials and/or combination of materials. Examples of suitable dielectric materials include, but are not limited to, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins, a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or a combination of any of the above materials. Additionally, in certain embodiments, the insulation of each of the electrical conductors utilized in the twisted pairs 105A-D may be formed from similar materials. In other embodiments, at least two of the twisted pairs may utilize different insulation materials. In yet other embodiments, the two conductors that make up a twisted pair 105 may utilize different insulation materials. As desired in certain embodiments, insulation may additionally include a wide variety of other materials (e.g., filler materials, materials compounded or mixed with a base insulation material, etc.), such as smoke suppressant materials, flame retardant materials, etc.

In various embodiments, twisted pair insulation 125 may be formed from one or multiple layers of insulation material. A layer of insulation may be formed as solid insulation, unfoamed insulation, foamed insulation, or other suitable insulation. As desired, combination of different types of insulation may be utilized. For example, a foamed insulation layer may be covered with a solid foam skin layer. As desired with foamed insulation, different foaming levels may be utilized for different twisted pairs in accordance with twist lay length to assist in balancing propagation delays between the twisted pairs. In certain embodiments, desired twisted pairs (e.g., twisted pairs 105A-D) incorporated into the cable 100 may have insulation that is formed from or that includes FEP. For example, the conductors of the twisted pairs 105A-D may be insulated with solid FEP insulation. Additionally, the twisted pair insulation 125 may be formed with any suitable thickness, inner diameter, outer diameter, and/or other dimensions.

In various embodiments, a desired number of the twisted pairs may be formed with different respective twist lays. For example, in the illustrated four pair cable, each of the twisted pairs 105A-D may have a different twist lay. The different twist lays may function to reduce crosstalk between the twisted pairs, and a wide variety of suitable twist lay configurations may be utilized. According to an aspect of the disclosure, the respective twist lays for the twisted pairs 105A-D may be selected, calculated, or determined in order to result in a cable 100 that satisfies one or more standards and/or electrical requirements. For example, twist lays may be selected such that the cable 100 satisfies one or more electrical requirements of a Category 5, Category 5e, Category 6, or Category 6A standard, such as the TIA 568.2-D standard set forth by the Telecommunications Industry Association. Twist lays may be selected as desired such that the cable 100 satisfies a wide variety of other electrical requirements, such as a propagation delay skew of less than approximately forty-five nanoseconds (45 ns) per one hundred meters (100 m) and/or a direct current resistance unbalance between any pairs (i.e., any two pairs of the cable 100) of less than approximately one hundred milliohms (100 mΩ) per one hundred meters (100 m).

In certain embodiments, the twist lays of the various twisted pairs 105A-D may account for a desired installation distance of the cable 100. For example, the twist lays may be selected and optimized to facilitate installation lengths exceeding 100 m. In various embodiments, the twist lays may be selected or optimized to facilitate installation lengths of up to 300 m, such as installation lengths of 150, 200, 250, or 300 m, installation lengths included in a range between any two of the above values, or installation lengths included in a range bounded on a maximum end by one of the above values. Additionally, in certain embodiments, the twist lays may be optimized for maximum installation lengths associated with a pulling force that the cable 100 can withstand. For example, if the cable 100 can withstand a pulling force associated with a 300 m installation length, then the twist lays may be selected to facilitate cable runs of up to 300 m that satisfy desired electrical performance parameters (e.g., Category standards, PoE standards, etc.).

In certain embodiments, the differences between twist lays of twisted pairs that are circumferentially adjacent one another (for example the twisted pair 105A and the twisted pair 105B) may be greater than the differences between twist lays of twisted pairs 105 that are diagonal from one another (for example the twisted pair 105A and the twisted pair 105C). As a result of having similar twist lays, the twisted pairs that are diagonally disposed can be more susceptible to crosstalk issues than the twisted pairs 105 that are circumferentially adjacent; however, the distance between the diagonally disposed pairs may limit the crosstalk. Thus, the different twist lays and arrangements of the pairs can help reduce crosstalk among the twisted pairs 105.

As desired, the plurality of twisted pairs 105A-D may be twisted together with an overall twist or bunch. Any suitable overall twist lay or bunch lay may be utilized, such as a bunch lay between approximately 1.9 inches and approximately 15.0 inches. For example, a bunch lay may be approximately 1.9, 2.0, 2.5, 3.0, 3.5, 3.75, 4.0, 4.25, 4.5, 4.75, 5.0, 5.5, 6.0, 7.0, 7.5, 8.0, 9.0, 10.0, 11.0, 12.0, or 15.0 inches, or any value included in a range between two of the previously listed values (e.g., a bunch lay between approximately 3.5 and approximately 4.5 inches, etc.), or any value included in a range bounded on either a minimum or maximum end by one of the above values (e.g., a bunch lay that is less than or equal to approximately 4.25 inches, etc.).

In certain embodiments, the twisted pairs 105A-D may each be twisted in the same direction (e.g., clockwise, counter-clockwise). An overall twist or bunching may then be formed in the same direction as the twisted pairs 105A-D (which tends to tighten the twist lays of each pair) or, alternatively, in an opposite direction from the twisted pairs (which tends to loosen the twist lays of each pair). In other embodiments, a first portion of the twisted pairs 105A-D may have a twist direction that is the same as the overall twist direction while a second portion of the twisted pairs 105A-D may have a twist direction that is opposite that of the overall twist direction. Any number of twisted pairs may be included in either the first portion or the second portion. Indeed, a wide variety of suitable combinations of twist lays and/or twist directions may be utilized as desired in order to obtain twisted pairs with desired final or resultant twist lays.

As desired in various embodiments, one or more suitable bindings or wraps may be wrapped or otherwise formed around the twisted pairs 105A-D (and/or other components of the cable 100) once the twisted pairs 105A-D are twisted together. Additionally, in certain embodiments, multiple grouping of twisted pairs may be incorporated into a cable. As desired, each grouping may be twisted, bundled, and/or bound together. Further, in certain embodiments, the multiple groupings may be twisted, bundled, or bound together.

With continued reference to FIG. 1, a jacket 115 may enclose the internal components of the cable 100, seal the cable 100 from the environment, and/or provide strength and structural support. The jacket 115 may be formed from a wide variety of suitable materials and/or combinations of materials, such as one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or a combination of any of the above materials. The jacket 115 may be formed as a single layer or, alternatively, as multiple layers. In certain embodiments, the jacket 115 may be formed from one or more layers of foamed material. As desired, the jacket 115 can include flame retardant and/or smoke suppressant materials. As shown, the jacket 115 may be formed to result in a round cable or a cable having an approximately circular cross-section; however, the jacket 115 and internal components may be formed to result in other desired shapes, such as an elliptical, oval, or rectangular shape. The jacket 115 may also have a wide variety of suitable dimensions, such as any suitable or desirable outer diameter and/or any suitable or desirable wall thickness. A few example outer diameters of the cable 100 are discussed in greater detail below. In various embodiments, the jacket 115 can be characterized as an outer jacket, an outer sheath, a casing, a circumferential cover, or a shell.

An opening enclosed by the jacket 115 may be referred to as a cable core, and the twisted pairs 105A-D and/or other cable components may be disposed within the cable core. In certain embodiments, one or more additional wires 110 (e.g., magnet wires, pulling elements, etc.) may be disposed within the cable core. In other embodiments, one or more additional wires 110 may be embedded within the jacket 115. In yet other embodiments, a cable 100 may include at least one first additional wire embedded in the jacket 115 and at least one second additional wire disposed in the cable core. Although a single cable core is illustrated in the cable 100 of FIG. 1, a cable may be formed to include multiple cable cores. In certain embodiments, the cable core may be filled with a gas such as air (as illustrated) or alternatively a gelatinous, solid, powder, moisture absorbing material, water-swellable substance, dry filling compound, or foam material, for example in interstitial spaces between the twisted pairs 105A-D and/or other internal cable components. Other elements can be added to the cable core as desired, for example, water absorbing materials, one or more rip cords, and/or one or more drain wires, depending upon application goals.

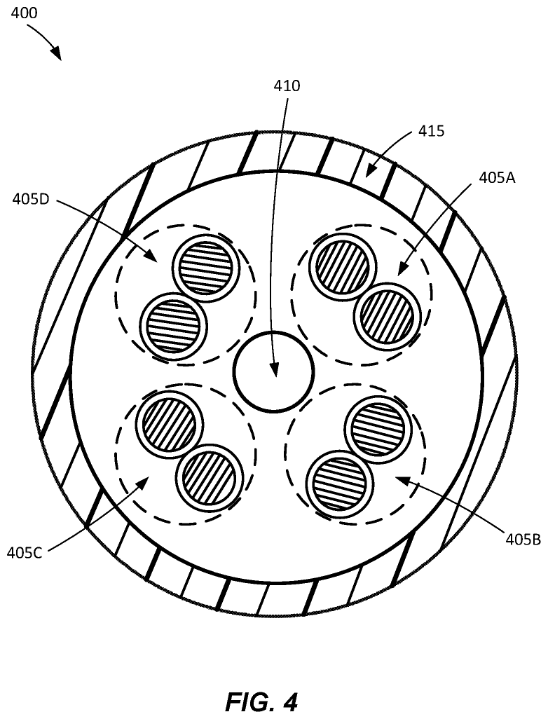

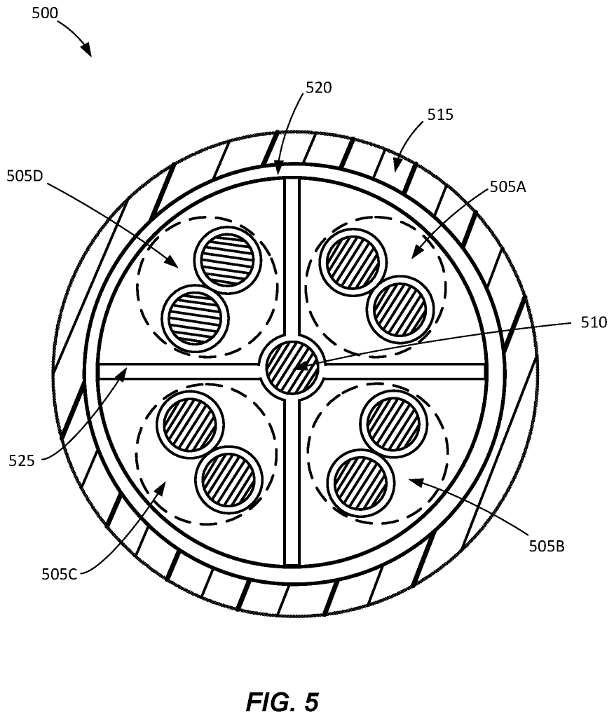

As desired in various embodiments, a suitable separator, spline, or filler may be positioned between two or more of the twisted pairs 105A-D. Although a separator is not illustrated in FIG. 1, example cables that include separators are illustrated in FIGS. 4 and 5. In the event that a cable includes a separator, the separator may be disposed within the cable core and configured to orient and or position one or more of the twisted pairs 105A-D. The orientation of the twisted pairs 105A-D relative to one another may provide beneficial signal performance. As desired in various embodiments, the separator may be formed in accordance with a wide variety of suitable dimensions, shapes, or designs. For example, the separator may be formed as an X-shaped separator or cross-fill. In other embodiments, a rod-shaped separator, a flat tape separator, a flat separator, a T-shaped separator, a Y-shaped separator, a J-shaped separator, an L-shaped separator, a diamond-shaped separator, a separator having any number of spokes extending from a central point, a separator having walls or channels with varying thicknesses, a separator having T-shaped members extending from a central point or center member, a separator including any number of suitable fins, and/or a wide variety of other shapes may be utilized.

In certain embodiments, the separator may be continuous along a longitudinal length of the cable 100. In other embodiments, the separator may be non-continuous or discontinuous along a longitudinal length of the cable 100. In other words, the separator may be separated, segmented, or severed in a longitudinal direction such that discrete sections or portions of the separator are arranged longitudinally (e.g., end to end) along a length of the cable 100. Use of a non-continuous or segmented separator may enhance the flexibility of the cable 100, reduce an amount of material incorporated into the cable 100, and/or reduce cost.

In certain embodiments, the separator may be characterized as having projections that extend from a central portion or spine. For example, a cross-filler may be viewed as having a plurality of projections that extend in different directions from a central portion, spine, or central point. In certain embodiments, the projections of a separator may be continuous along a longitudinal length of the separator (or a separator section in a severed separator). In other embodiments, one or more projections of a separator may have sections or portions that are spaced along a longitudinal length of the separator, and any suitable longitudinal gap or spacing may be positioned between longitudinally adjacent sections of a projection. Longitudinal gaps utilized between sections of a projection may have any suitable lengths or sized, and gaps may be approximately equal in length and/or spacing (e.g., arranged in accordance with a desired pattern, etc.) or alternatively, arranged in a random or pseudo-random manner. The use of longitudinal spaces between adjacent sections of a projection or between adjacent sets of projections (e.g., spaced grouping of projections or prongs) may facilitate a reduction in material utilized to form the separator and/or may enhance the flexibility of the separator.

In certain embodiments, projections may extend from a central portion in different sets of one or more directions at longitudinally spaced locations. For example, a first set of one or more projections may extend in a first set of respective directions. A second set of one or more projections longitudinally adjacent to the first set may extend in a second set of respective directions, and at least one direction of extension in the second set may be different than the direction(s) of extension included in the first set. Regardless of whether longitudinal gaps are positioned between various sets of longitudinally spaced projections, any suitable number of projections (e.g., one, two, three, four, etc.) may extend at each longitudinally spaced location. In certain embodiments, directions of extension may be varied in order to reduce material utilized to form the separator while still providing a separator with a desired overall cross-sectional shape. For example, a separator may function as a cross-filler that includes projections extending in four directions along a longitudinal length; however, at any given location along the longitudinal length, projections may not extend in all four directions. A wide variety of suitable configurations of projections may be utilized as desired. In certain embodiments, a single projection may extend from each longitudinally spaced location, and the projections may alternate directions of extension, for example, at approximately ninety-degree (90°) angles or in accordance with any other suitable pattern. In other embodiments, two projections may extend from each longitudinally spaced location in opposite directions from a central portion, and the directions of extension may alternate by approximately one hundred and eighty degrees (180°) between adjacent spaced locations. In other embodiments, two projections may extend from each longitudinally spaced location with an approximately ninety-degree (90°) angle between the two projections. The directions of extension for the two projections may then be varied between adjacent longitudinally spaced locations. In yet other embodiments, three projections may extend from each longitudinally spaced location, and a projection that is not present may be alternated or otherwise varied along a longitudinal length. For example, a projection that is not present may be alternated at approximately ninety-degree (90°) angles at adjacent longitudinally spaced locations. Additionally, in certain embodiments, the same number of projections may extend from each of the longitudinally spaced locations. In other examples, different numbers of projections may extend from at least two longitudinally spaced locations. A wide variety of other projection configurations and/or variations may be utilized as desired.

For a cross-filler or other separator that includes projections that extend between adjacent sets of twisted pairs 105A-D, each projection may be formed with a wide variety of suitable dimensions. For example, each projection may have a wide variety of suitable cross-sectional shapes at a given cross-sectional point perpendicular to a longitudinal direction of the separator, cross-sectional shapes taken along the longitudinal direction (e.g., rectangular, square, semi-circular, parallelogram, trapezoidal, triangular, etc.), cross-sectional areas, thicknesses, distances of projection (i.e., length of projection from the central portion), and/or longitudinal lengths. In certain embodiments, each projection may be formed with substantially similar dimensions. In other embodiments, at least two projections may be formed with different dimensions. Similarly, in certain embodiments, each projection may be formed from similar materials. In other embodiments, at least two projections may be formed from different materials.

A wide variety of suitable techniques may be utilized to form a separator. For example, in certain embodiments, material may be extruded, cast, molded, or otherwise formed into a desired shape to form the separator. In other embodiments, various components of a separator may be separately formed, and then the components of the separator may be joined or otherwise attached together via adhesive, bonding (e.g., ultrasonic welding, etc.), or physical attachment elements (e.g., staples, pins, etc.). In yet other embodiments, a tape may be provided as a substantially flat separator or formed into another desired shape utilizing a wide variety of folding and/or shaping techniques. For example, a relatively flat tape may be formed into an X-shape or cross-shape as a result of being passed through one or more dies. In other embodiments, a plurality of tapes may be combined in order to form a separator having a desired cross-sectional shape. For example, two tapes may be folded at approximately ninety-degree angles and bonded together to form a cross-shaped separator. As another example, four tapes may be folded at approximately ninety-degree angles and bonded to one another to form a cross-shaped separator. A wide variety of other suitable construction techniques may be utilized as desired. Additionally, in certain embodiments, a separator may be formed to include one or more hollow cavities that may be filled with air or some other gas, one or more magnet wires, pulling elements, or other additional wires 110, moisture mitigation material, a drain wire, shielding, or some other appropriate components.

The separator (and/or various segments, projections, and/or other components of the separator) may be formed from a wide variety of suitable materials and/or combinations of materials as desired in various embodiments. For example, the separator may include paper, metallic material (e.g., aluminum, ferrite, etc.), alloys, semi-conductive materials, ferrite ceramic materials, various plastics, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or any other suitable material or combination of materials. As desired, the separator may be filled, unfilled, foamed, solid, homogeneous, or inhomogeneous and may or may not include additives (e.g., flame retardant and/or smoke suppressant materials). In certain embodiments, a separator may include or incorporate one or more shielding materials, such as electrically conductive shielding material, semi-conductive material, and/or dielectric shielding material (e.g., ferrite ceramic material, etc.). As a result of incorporating electrically conductive material, the separator may function as a shielding element.

In certain embodiments, each segment of a severed or subdivided separator may be formed from similar materials. In other embodiments, a separator may make use of alternating materials in adjacent portions or segments. For example, a first portion or segment of the separator may be formed from a first set of one or more materials, and a second portion or segment of the separator may be formed from a second set of one or more materials. As one example, a relatively flexible material may be utilized in every other portion of a separator. As another example, flame retardant material may be selectively incorporated into desired portions of a separator. In this regard, material costs may be reduced while still providing adequate flame retardant qualities.

As desired in various embodiments, one or more shield elements or shielding elements may be incorporated into the cable 100. Each shielding element may incorporate one or more shielding materials, such as electrically conductive shielding material, semi-conductive material, and/or dielectric shielding material (e.g., ferrite ceramic material, etc.). Examples of suitable shield layers that may be utilized as shielding elements include, but are not limited to, an overall shield formed around the twisted pairs 105A-D (as shown in FIGS. 2, 3, and 5), individual shield layers respectively formed around each of the twisted pairs 105A-D, one or more shield layers formed around desired subgroups of the twisted pairs 105A-D, and/or various combinations of shield layers. As set forth above, shielding material may also be incorporated into cable separators or fillers positioned between two or more of the pairs 105A-D. Similarly, shielding material may be incorporated into separation elements (e.g., film layers, etc.) that are positioned between the individual conductors of one or more twisted pairs. Indeed, a wide variety of suitable shielding configurations, shield elements, and/or combinations of shield elements may be utilized.

In certain embodiments, a shield layer, such as an overall shield layer, may be positioned within a cable core. In other embodiments, a shield layer may be incorporated into the outer jacket 115. For example, a shield layer may be sandwiched between two other layers of outer jacket material, such as two dielectric layers. As another example, electrically conductive material or other shielding material may be injected or inserted into the outer jacket 115 or, alternatively, the outer jacket 115 may be impregnated with shielding material. A wide variety of other suitable shielding arrangements may be utilized as desired in other embodiments. Further, in certain embodiments, a cable 100 may include a separate, armor layer (e.g., a corrugated armor, etc.) for providing mechanical protection. In other embodiments, the cable 100 may be formed without a separate armor layer (e.g., corrugated armor, interlocked armor, etc.). As a result of not including an armor layer, an outer diameter of the cable 100 can be reduced.

An example external or overall shield layer (such as those illustrated in FIGS. 2, 3, and 5) or shield will now be described herein in greater detail; however, it will be appreciated that other shield layers may have similar constructions. In certain embodiments, a shield may be formed from a single segment or portion that extends along a longitudinal length of the cable 100. In other embodiments, a shield may be formed from a plurality of discrete segments or portions positioned adjacent to one another along a longitudinal length of the cable 100. In the event that discrete segments or portions are utilized, in certain embodiments, gaps or spaces may exist between adjacent segments or portions. In other embodiments, certain segments may overlap one another. For example, an overlap may be formed between segments positioned adjacent to one another in a longitudinal direction.

As desired, a wide variety of suitable techniques and/or processes may be utilized to form a shield (or a shield segment). For example, a shield may be formed from continuous electrically conductive material (e.g., an aluminum foil layer, etc.). As another example, a shield may be formed as a braided shield. As yet another example, a base material or dielectric material may be extruded, pultruded, or otherwise formed. Electrically conductive material or other shielding material may then be applied to the base material. In other embodiments, shielding material may be injected into the base material. In other embodiments, dielectric material may be formed or extruded over shielding material in order to form a shield. Indeed, a wide variety of suitable techniques may be utilized to incorporate shielding material into a base material.

In certain embodiments, the shield (or individual shield segments) may be formed as a tape that includes both a dielectric layer and an electrically conductive layer (e.g., copper, aluminum, silver, an alloy, etc.) formed on one or both sides of the dielectric layer. Examples of suitable materials that may be used to form a dielectric layer include, but are not limited to, various plastics, one or more polymeric materials, one or more polyolefins (e.g., polyethylene, polypropylene, etc.), one or more fluoropolymers (e.g., fluorinated ethylene propylene (“FEP”), polyester, polytetrafluoroethylene, polyimide, or some other polymer, combination of polymers, aramid materials, or dielectric material(s) that does not ordinarily conduct electricity. In certain embodiments, a separate dielectric layer and electrically conductive layer may be bonded, adhered, or otherwise joined (e.g., glued, etc.) together to form the shield. In other embodiments, electrically conductive material may be formed on a dielectric layer via any number of suitable techniques, such as the application of metallic ink or paint, liquid metal deposition, vapor deposition, welding, heat fusion, adherence of patches to the dielectric, or etching of patches from a metallic sheet. In certain embodiments, the conductive patches can be over-coated with an electrically insulating film, such as a polyester coating. Additionally, in certain embodiments, an electrically conductive layer may be sandwiched between two dielectric layers. In other embodiments, at least two electrically conductive layers may be combined with any number of suitable dielectric layers to form the shield. For example, a four-layer construction may include respective electrically conductive layers formed on either side of a first dielectric layer. A second dielectric layer may then be formed on one of the electrically conductive layers to provide insulation between the electrically conductive layer and the twisted pairs 105A-D. Indeed, any number of suitable layers of material may be utilized in a shield 130.

Additionally, in certain embodiments, one or more separator elements (not shown) may be positioned between the individual conductors of a twisted pair 105. As desired, shielding material may be optionally incorporated into one or more separator elements positioned between the conductors of respective twisted pairs 105A-D. In certain embodiments, a twisted pair separator may be woven helically with the individual conductors or conductive elements of an associated twisted pair 105. In other words, a separator element may be helically twisted with the conductors of a twisted pair 105 along a longitudinal length of the cable 100.

Each separator element may have a wide variety of suitable constructions, components, and/or cross-sectional shapes. For example, each separator may be formed as a dielectric film that is positioned between the two conductors of a twisted pair 105. In other embodiments, a separator may be formed with an H-shape, an X-shape, or any other suitable cross-sectional shape. For example, the separator may be formed to create or define one or more channels in which the twisted pair conductors may be situated. In this regard, the separator may assist in maintaining the positions of the twisted pair conductors when stresses are applied to the cable, such as pulling and bending stresses. Additionally, in certain embodiments, a separator may include a first portion positioned between the conductors of a twisted pair 105 and one or more second portions that form a shield around an outer circumference of the twisted pair. The first portion may be helically twisted between the conductors, and the second portion(s) may be helically twisted around the conductors as the separator and the pair 105 are twisted together. The first portion or dielectric portion may assist in maintaining spacing between the individual conductors of the twisted pair 105 and/or maintaining the positions of one or both of the individual conductors. The second portion(s) or shielding portions may extend from the first portion, and the second portion(s) may be individually and/or collectively wrapped around the twisted pair conductors in order to form a shield layer.

As set forth above, a wide variety of different components of a cable may function as shielding elements. In certain embodiments, the electrically conductive material or other shielding material incorporated into a shield element may be relatively continuous along a longitudinal length of a cable. For example, a relatively continuous foil shield or braided shield may be utilized. In other embodiments, a shield element may be formed as a discontinuous shield element having a plurality of isolated patches of shielding material. For example, a plurality of discontinuous patches of electrically conductive material may be incorporated into the shield element (or into various components of a shield element), and gaps or spaces may be present between adjacent patches in a longitudinal direction. A wide variety of different patch patterns may be formed as desired in various embodiments, and a patch pattern may include a period or definite step. In other embodiments, patches may be randomly formed or situated on a base or carrier layer.

A wide variety of suitable shielding materials may be utilized to form patches of shielding material. Examples of suitable electrically conductive materials that may be utilized include, but not limited to, metallic material (e.g., silver, copper, nickel, steel, iron, annealed copper, gold, aluminum, etc.), metallic alloys, conductive composite materials, etc. Indeed, suitable electrically conductive materials may include any material having an electrical resistivity of less than approximately 1×10⁻⁷ ohm meters at approximately 20° C. In certain embodiments, an electrically conductive material may have an electrical resistivity of less than approximately 3×10⁻⁸ ohm meters at approximately 20° C. Electrically conductive material incorporated into a shield may have any desired thickness, such as a thickness of about 0.5 mils (about 13 microns) or greater.

Additionally, for shields that include discontinuous or spaced patches of electrically conductive material, a wide variety of suitable patch lengths (e.g., lengths along a longitudinal direction of a cable) may be utilized. As desired, the dimensions of the segments and/or electrically conductive patches can be selected to provide electromagnetic shielding over a specific band of electromagnetic frequencies or above or below a designated frequency threshold. Individual patches may be separated from one another so that each patch is electrically isolated from the other patches. That is, the respective physical separations between the patches may impede the flow of electricity between adjacent patches. In certain embodiments, the physical separation of patches may be formed by gaps or spaces, such as gaps of dielectric material. In other embodiments, the physical separation of certain patches may result from the overlapping of shield segments. For example, a shield element may be formed from a plurality of discrete segments, and adjacent segments may overlap one another. The respective physical separations between the patches may impede the flow of electricity between adjacent patches. A wide variety of suitable gap distances or isolation gaps may be provided between adjacent patches. Additionally, in certain embodiments, patches may be formed as first patches (e.g., first patches on a first side of a dielectric material), and second patches may be formed on an opposite side of a dielectric base layer. For example, second patches may be formed to correspond with the gaps or isolation spaces between the first patches. As desired, patches may have a wide variety of different shapes and/or orientations. For example, the segments and/or patches may have a rectangular, trapezoidal, parallelogram, triangular, or any other desired shape.

According to an aspect of the disclosure, one or more additional wires 110 may be incorporated into the cable 100. The additional wire(s) may constitute wires or longitudinally continuous conductive elements other than the wires or conductors included in the twisted pairs 105A-D (e.g., the four illustrated twisted pairs). In certain embodiments, the one or more additional wires 110 may include one or more magnet wires or winding wires (also referred to herein as magnet wire(s) 110). A magnet wire 110 may include a conductor and thin film insulation formed around the conductor. According to an aspect of the disclosure, the insulation formed around the magnet wire conductor may include at least one layer formed from a thermoset polymeric material. Any number of suitable enamel insulation layers may be formed around a magnet wire conductor as desired in various embodiments of the disclosure. Although FIG. 1 illustrates an example bare or uninsulated additional conductor 110, FIG. 2 illustrates an example additional conductor 110 that includes insulation. It is appreciated that an insulated magnet wire may be utilized as an additional conductor 110 in the cable 100 of FIG. 1 and/or in any of the other example cables illustrated and described herein.

The conductor of a magnet wire 110 may be formed from a wide variety of suitable materials or combinations of materials. For example, the conductor may be formed from copper, aluminum, annealed copper, oxygen-free copper, silver-plated copper, nickel plated copper, copper clad aluminum (“CCA”), silver, gold, a conductive alloy, a bimetal, or any other suitable electrically conductive material. Additionally, the conductor may be formed with any suitable cross-sectional shape, such as the illustrated circular or round cross-sectional shape. In other embodiments, a conductor may have a rectangular, square, elliptical, oval, or any other suitable cross-sectional shape. As desired for certain cross-sectional shapes such as a rectangular shape, a conductor may have corners that are rounded, sharp, smoothed, curved, angled, truncated, or otherwise formed.

The conductor and the magnet wire 110 incorporating the conductor may also be formed with any suitable dimensions, such as any suitable gauge, diameter, height, width, cross-sectional area, etc. In certain embodiments, the magnet wire 110 may be formed as a 35 AWG wire or larger. For example, the magnet wire 110 may be formed as a 30 AWG wire. In various embodiments, the magnet wire 110 may be a 35, 34, 33, 32, 31, 30, 29, 28, 27, 26, 25, 24, 23, 22, 21, or 20 AWG wire, a wire included in a range between any two of the previously mentioned gauges, or a wire included in a range bounded on the minimum end by one of the previously mentioned gauges (e.g., 35 AWG or larger, etc.). Similarly, in certain embodiments, the magnet wire 110 may have a cross-sectional area of at least approximately 0.0160 mm². In various embodiments, the magnet wire 110 may have a cross-sectional area of at least approximately, 0.0160, 0.0201, 0.0254, 0.0320, 0.0404, 0.0509, 0.0642, 0.0810, 0.102, 0.129, 0.162, 0.205, 0.258, 0.326, 0.410, or 0.518 mm², or a cross-sectional area included in a range between any two of the previously mentioned values.

According to an aspect of the disclosure, the insulation formed around the conductor of a magnet wire 110 may include at least one enamel layer. An enamel layer is typically formed by applying a polymeric varnish to the conductor (or on an underlying enamel layer) and then baking the wire in a suitable enameling oven or furnace. The polymeric varnish typically includes thermosetting polymeric material or resin suspended in one or more solvents. A thermosetting or thermoset polymer is a material that may be irreversibly cured from a soft solid or viscous liquid (e.g., a powder, etc.) to an insoluble or cross-linked resin. Thermosetting polymers typically cannot be melted for application via extrusion as the melting process will break down or degrade the polymer. Thus, thermosetting polymers are suspended in solvents to form a varnish that can be applied and cured to form enamel film layers. Following application of a varnish, solvent is removed as a result of baking or other suitable curing, thereby leaving a solid polymeric enamel layer. As desired, a plurality of layers of enamel may be applied to the conductor in order to achieve a desired enamel thickness or build (e.g., a thickness of the enamel obtained by subtracting the thickness of the conductor and any underlying layers). Each enamel layer may be formed utilizing a similar process. In other words, a first enamel layer may be formed, for example, by applying a suitable varnish and passing the conductor through an enameling oven. A second enamel layer may subsequently be formed by applying a suitable varnish and passing the conductor through either the same enameling oven or a different enameling oven. Indeed, an enameling oven may be configured to facilitate multiple passes of a wire through the oven. As desired in various embodiments, other curing devices may be utilized in addition to or as an alternative to one or more enameling ovens. For example, one or more suitable infrared light, ultraviolet light, electron beam, and/or other curing systems may be utilized.

Any number of suitable enamel layers may be formed around a magnet wire conductor as desired in various embodiments. In certain embodiments, various enamel layers may have different constructions (e.g., different polymeric materials, optional fillers, etc.). For example, in certain embodiments, a magnet wire 110 may include a solcoat or a single type of enamel insulation. As another example, a magnet wire 110 may include a basecoat and a topcoat of enamel, and the basecoat and topcoat may have different constructions. As yet another example, a magnet wire 110 may include a basecoat, a midcoat, and a topcoat insulation layer, and at least two of the enamel layers may have different constructions. As desired, each layer of enamel may be formed with any suitable number of sublayers. For example, a basecoat may include a single enamel layer or, alternatively, a plurality of enamel layers or sublayers that are formed until a desired build or thickness is achieved. Each layer of enamel and/or a total of all of the layers of enamel may have any desired thickness, such as a thickness of approximately 0.0002, 0.0005, 0.007, 0.001, 0.002, 0.003, 0.004, 0.005, 0.006, 0.007, 0.008, 0.009, 0.010, 0.012, 0.015, 0.017, or 0.020 inches, a thickness included in a range between any two of the aforementioned values, and/or a thickness included in a range bounded on either a minimum or maximum end by one of the aforementioned values. In certain embodiments, the example thickness values may apply to the thickness of an enamel layer or overall enamel system. In other embodiments, the example thickness values may apply to the build (e.g., a change in overall thickness of a wire resulting from addition of enamel, twice the thickness of an enamel layer or enamel system, the thickness on both sides of a wire resulting from the enamel layer or enamel system, etc.) of an enamel layer or overall enamel system. In yet other embodiments, the example thickness values provided above may be doubled in order to provide example build thickness values for an enamel layer or enamel system. Indeed, a wide variety of different wire constructions may be formed with any number of enamel layers having any suitable thicknesses.

A wide variety of different types of polymeric materials may be utilized as desired to form an enamel layer. Examples of suitable thermosetting materials include, but are not limited to, polyimide, polyamideimide, amideimide, polyester, polyesterimide, polysulfone, polyphenylenesulfone, polysulfide, polyphenylenesulfide, polyetherimide, polyamide, polyketones, etc. In certain embodiments, an enamel layer may be formed from a single polymeric material. In other embodiments, an enamel layer may be formed from a blend of multiple polymeric materials. If an enamel layer is formed from a blend, any suitable blend ratio of different polymeric materials may be utilized. Additionally, as set forth above, in certain embodiments, a plurality of layers of enamel may be formed from the same polymeric material. In other embodiments, at least two different layers of enamel may be formed from different materials. For example, a magnet wire 110 may include a polyester basecoat and a topcoat formed from a different material, such as polyamideimide. A wide variety of different combinations of polymeric materials may be utilized as desired in order to form different insulation systems.

In certain embodiments, one or more suitable surface modification treatments may be utilized on a conductor and/or any number of enamel layers to promote adhesion with a subsequently formed enamel layer and reduce interlayer delamination. Examples of suitable surface modification treatments include, but are not limited to, a plasma treatment, an ultraviolet (“UV”) treatment, a corona discharge treatment, and/or a gas flame treatment. As desired, one or more suitable additives may be incorporated into an enamel layer. An additive may serve a wide variety of suitable purposes, such as promotion of adhesion between various components and/or layers of a magnet wire 110, enhancing the flexibility of the insulation incorporated into a magnet wire 110, and/or enhancing moisture resistance. A wide variety of different materials may be incorporated into a magnet wire 110 as additives in various embodiments. Additionally, in certain embodiments, one or more filler materials may be incorporated into an enamel layer. A wide variety of suitable filler materials may be utilized as desired including, but not limited to, metallic materials, metal oxides (e.g., silica oxide, titanium oxide, chromium oxide, etc.), blends of various materials (e.g., a blend of two metal oxides, etc.), etc. Filler materials may be incorporated into an enamel layer at any suitable ratio by weight percentage. For example, a filler material may occupy between approximately five percent (5%) and forty percent (40%) by weight of an enamel insulation layer. In the event that a filler includes a blend of materials, the component materials may be blended together at a wide variety of suitable ratios by weight. Additionally, the filler materials incorporated into an enamel layer may have a wide variety of suitable particle sizes. For example, nanoparticles may be incorporated into an enamel layer as filler materials.

As desired in certain embodiments, one or more other layers of insulation may be incorporated into a magnet wire 110 in addition to one or more enamel layers. For example, one or more extruded thermoplastic layers (e.g., an extruded overcoat, etc.), semi-conductive layers, tape insulation layers (e.g., polymeric tapes, etc.), and/or conformal coatings (e.g., a parylene coating, etc.) may be incorporated into a magnet wire 110. A wide variety of other insulation configurations and/or layer combinations may be utilized as desired. Additionally, an overall insulation system may include any number of suitable sublayers formed from any suitable materials and/or combinations of materials.

In certain embodiments, a magnet wire 110 may extend along a longitudinal direction of the cable 100 such that it is parallel to the twisted pairs 105A-D. In other words, the magnet wire 110 may not be twisted or stranded with the twisted pairs 105A-D or other components of the cable 100. In other embodiments, a magnet wire 110 may be helically twisted, SZ stranded, or otherwise stranded with the twisted pairs 105A-D along a longitudinal length of the cable 100. For example, the magnet wire 110 may be bunched and helically twisted with the twisted pairs 105A-D with an overall bunch lay.

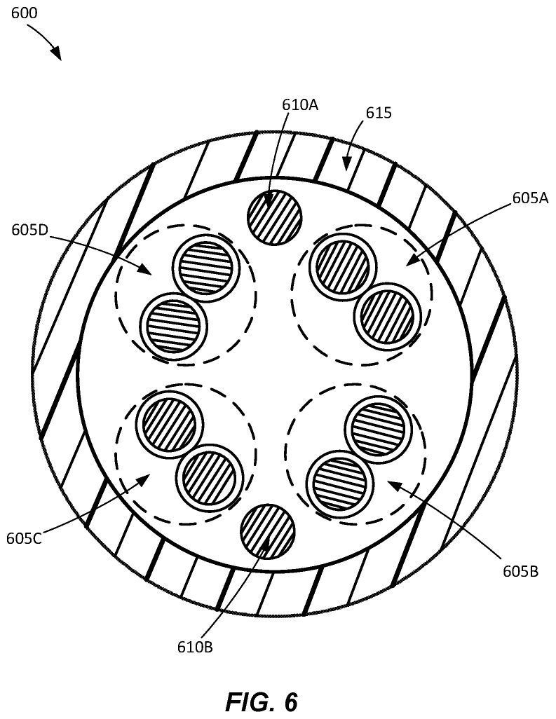

Additionally, any number of suitable magnet wires may be incorporated into a cable 100 as desired in various embodiments. As shown in FIGS. 1 and 2, in certain embodiments, a single magnet wire 110 may be incorporated into the cable. In other embodiments, a plurality (e.g., two, three, four, etc.) of magnet wires may be incorporated into a cable 100. FIGS. 6-8, which are described in greater detail below, illustrate a few example cables that include a plurality of additional wires (e.g., a plurality of magnet wires and/or pulling elements). In the event that a plurality of magnet wires are utilized, in certain embodiments, each of the magnet wires may have similar constructions. In other embodiments, at least two magnet wires may be formed with different constructions. For example, at least two magnet wires may be formed with different materials (e.g., different insulation layers, etc.) or at least two magnet wires may be formed with different dimensions.

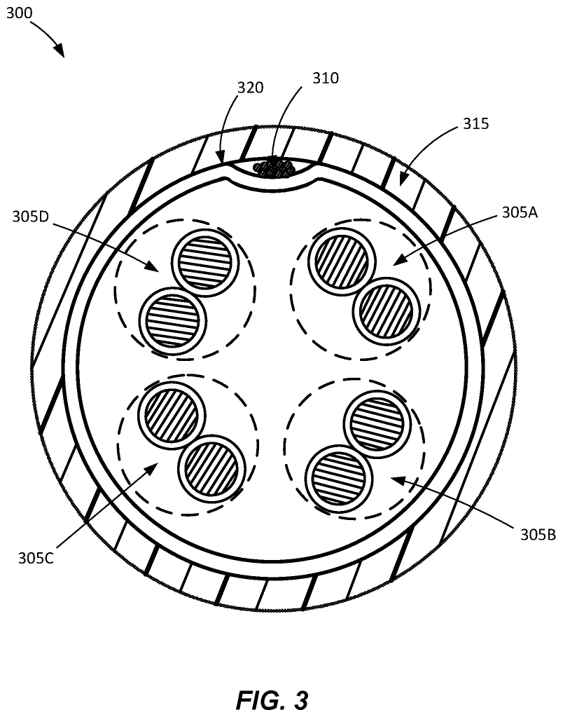

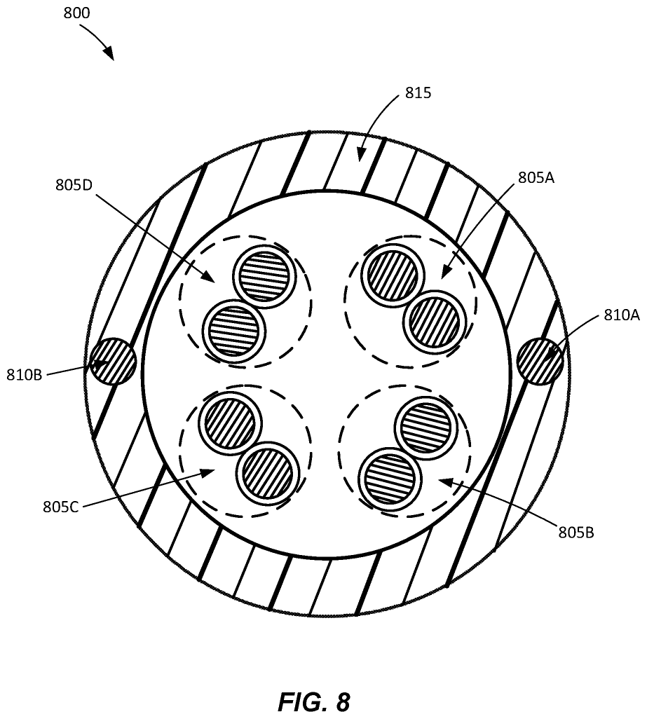

One or more magnet wries 110 may also be positioned at a wide variety of suitable locations within a cable 100. In certain embodiments, one or more magnet wires 110 may be positioned between the twisted pairs 105A-D and the cable jacket 115. For example, as shown in FIG. 1, one or more magnet wires 110 may be positioned or situated around an outer periphery of the twisted pairs 105A-D. In the event that a cable 100 includes an outer shield layer, one or more magnet wires 110 may be positioned inside the shield layer (as shown in FIG. 2) or outside the shield layer (as shown in FIG. 3). In other embodiments, as shown in FIG. 4, one or more magnet wires 110 may be positioned between the plurality of twisted pairs 105A-D. For example, a magnet wire 110 may longitudinally extend along a cross-sectional centerline of a cable 100. In yet other embodiments, as shown in FIG. 5, one or more magnet wires 110 may be incorporated into or positioned within a cable separator. For example, a magnet wire 110 may be positioned within a longitudinally extending cavity or pocket of a separator. In yet other embodiments, as shown in FIG. 8, one or more magnet wires 110 may be embedded within the cable jacket 115. As desired in other embodiments, a plurality of magnet wires 110 may be positioned at different locations within a cable 100. For example, a first magnet wire may be positioned between the plurality of twisted pairs 105A-D while a second magnet wire is positioned outside an outer periphery of the twisted pairs 105A-D. A wide variety of other suitable configurations of magnet wires may be utilized as desired.

A magnet wire 110 incorporated into a cable as an additional wire may be utilized for a wide variety of suitable purposes. For example, a magnet wire 110 may be utilized to transmit desired data and/or power signals. As another example, a magnet wire 110 may be utilized as a toning wire, a tracer wire, or as a testing wire within a cable 100. As yet another example, a magnet wire 110 may be sized sufficiently such that it constitutes a pulling element similar to those described in greater detail below. In other words, a magnet wire 110 may bear a desired portion (e.g., a majority, etc.) of a tensile load and/or a pulling load imparted upon a cable 100 when it is installed. In other embodiments, a magnet wire 100 may assist in dissipating heat within a cable 100. In yet other embodiments, a magnet wire 100 may simply constitute an additional wire in a four twisted pair cable (e.g., a ninth wire, etc.).

In certain embodiments, incorporation of one or more relatively small magnet wires 110 may result in limited or approximately no change in the outer diameter size of a cable 100. In other words, a cable 100 may incorporate one or more magnet wires 110 while maintaining a relatively small outer diameter. In certain embodiments, a cable 100 having four twisted pairs 105A-D may have an outer diameter of approximately 10 mm or less. In various embodiments, the cable 100 may have an outer diameter of less than approximately 5, 6, 7, 8, 9, or 10, or an outer diameter included in a range between any two of the above values.

In other embodiments, the one or more additional wires 110 incorporated into a cable 100 may include one or more pulling elements or tensioning elements (also referred to herein as pulling element(s) 110). The pulling element(s) 110 allow an increased pulling force to be imparted on the cable 100 without elongating the conductors of the twisted pairs 105A-D. In this regard, the cable 100 may be pulled and installed at longitudinal lengths greater than 100 m. When integrated or incorporated into the cable 100, the pulling element(s) 110 may bear a majority of a pulling load or pulling tension imparted onto the cable 100, thereby reducing or limiting the tension placed on the twisted pairs 105A-D. In certain embodiments, the pulling element(s) 110 may be coupled to other components of the cable 100, such as the twisted pairs 105A-D, with regards to bearing a pulling load. When components of the cable 100, such as the twisted pairs 105A-D and the pulling element(s) 110 are coupled together, the components may be pulled at the same rate such that they experience the same elongation. Given the twists imparted on the twisted pairs 105A-D, the pairs 105A-D will elongate less than untwisted or straight components, such as the pulling element(s) 110. Additionally, due to the pulling element(s) 110 having a higher elastic modulus than the other cable components, the pulling element(s) 110 may bear the pulling load or a suitable portion of the pulling load to prevent damage or untwisting of the pairs 105A-D.

As mentioned above, applicable cable standards specify a maximum pulling force for a four-pair cable of 110 N. Similarly, the TANK equation or method is commonly used within the twisted pair cable industry to calculate a maximum pulling force or pulling tension that may be imparted on a cable. The TANK equation, or T=A·N·K states that the maximum allowable pulling tension (T) is equal to the cross-sectional area of the conductor in circular mils (A) multiplied by the number of conductors (N) multiplied by a constant (K). The constant “K” commonly used for copper conductors is 0.008 pounds per circular mil. Additionally, a four pair cable will include eight conductors. Table 1 below sets forth some TANK calculations for four pair cables with common conductor sizes or gauges:

TABLE 1
Example Maximum Pulling Tensions Using the TANK Equation

| | Conductor | Maximum | Maximum |
|---|---|---|---|
| | Cross-sectional | Pulling | Pulling |
| Conductor | Area in | Tension | Tension |
| Gauge | Circular Mils (A) | (T) in lbs. | (T) in N |
| 24 AWG | 396 | 25.34 | 112.7 |
| 22 AWG | 625 | 40 | 177.9 |

As shown above, the TANK calculation for a 24 AWG cable is similar to the maximum pulling force or tension permitted by applicable cable standards. Although a cable with larger conductors can withstand a slightly higher pulling force, the maximum allowable pulling force for those conductors is still inadequate for longer installations (e.g., installations at lengths exceeding 100 m) and/or for installations in which the cable may encounter higher coefficients of friction. In other words, the twisted pairs may be subject to unwanted elongation in certain installation environments. Unwanted elongation of the twisted pairs 105A-D may result in damage to the pair conductors and/or increase of one or more twist lays that may negatively impact the electrical performance of the cable.

A cable 100 having one or more integrated pulling elements 110 may facilitate pulling loads greater than 110 N (as allowed by applicable standards) or those calculated via use of the TANK equation. In certain embodiments, a cable 100 having one or more pulling elements 110 may withstand a pulling load, force or tension of at least 330 N with an elongation on the cable of less than 0.20 percent. In various embodiments, a cable 100 may withstand a pulling load of at least 220 N, 250 N, 275 N, 300 N, 325 N, 350 N, 375 N, or 400 N, or a pulling load incorporated into a range between any of the above values, with an elongation on the cable of less than 0.20 percent. The maximum cable elongation may define the maximum amount that any components of the cable will stretch or elongate in the longitudinal direction in relation to the original cable length. In certain embodiments, the cable 100 may withstand a pulling load equal to a maximum installation length of the cable 100 multiplied by 110 N per each 100 m of maximum installation length. For example, if the cable 100 is intended for installation at lengths of up to 300 m, then the cable 100 may withstand a pulling load of 300 m×(300/100)×110 or approximately 330 N with a maximum elongation on the cable of less than 0.20 percent. In other embodiments, a cable 100 may be designed to withstand any of the pulling loads set forth above (e.g., 330 N, etc.) with an elongation on the cable 100 of less than 0.06, 0.075, 0.1, 0.15, 0.25, 0.3, 0.4, 0.5, 0.75, or 1.0 percent, or a maximum elongation included in a range between any of the above values.

In certain embodiments, a cable 100 can withstand a higher pulling load or force (e.g., a force of at least 330N) while still permitting the twisted pairs 105A-D to satisfy desired electrical performance criteria. For example, after pulling, the twisted pairs 105A-D may satisfy desired data transmission and bit error rates associated with an intended application for the cable 100. In certain embodiments, after the cable 100 has been subjected to a pulling load of 330 N, the twisted pairs 105A-D may still satisfy the electrical performance requirements of at least one of IEEE 802.3i for 10BASE-T 10 Mbit/s Ethernet transmission over twisted pairs (as published by IEEE in 1990), IEEE 802.3u for 100BASE-T 100 Mbit/s Ethernet transmission over twisted pairs (as published by IEEE in 1995), IEEE 802.3ab for 1000BASE-T 1 Gbit/s Ethernet transmission over twisted pairs (as published by IEEE in 1999), IEEE 802.3an for 10GBASE-T 10 Gbit/s Ethernet transmission over twisted pairs (as published by IEEE in 2006), or any other suitable standards that establish data transmission, bit error rate, and/or other electrical performance criteria for transmitting Ethernet and/or other signals over twisted pairs.

A pulling element 110 may be formed with a wide variety of suitable constructions as desired in various embodiments. For example, a pulling element 110 may be formed from a wide variety of suitable materials and/or with a wide variety of suitable dimensions. In certain embodiments, a pulling element 110 may be formed from one or more metallic materials. Examples of suitable metal materials include, but are not limited to, steel, ferritic steel, stainless steel, ferritic stainless steel, carbon steel, cold drawn steel, tool steel, titanium, cobalt, chromium, beryllium, any suitable metallic alloy, etc. In general, a metallic material having a higher elastic modulus than the electrically conductive material used in the twisted pair conductors (e.g., copper, etc.) may be utilized. Additionally, the relatively high elastic modulus of a metallic material may permit formation of a pulling element 110 with a relatively small diameter or cross-sectional area. As a result, incorporation of a pulling element 110 into a cable 100 may have a relatively small or no impact on an outside diameter of a cable 100. In other words, relatively small twisted pair cables may be formed that include one or more pulling elements 110.

Additionally, in the event that one or more metallic materials are used to form a pulling element 110, the pulling element 110 may be used as a tracer wire in the cable 100. For example, a metallic pulling element (e.g., a ferritic metallic pulling element, etc.) may be used to trace a buried or in-duct cable 100 utilizing a magnetic flux detector or other suitable device. This eliminates the need of energizing a twisted pair conductor to trace the conductor/cable and allows the pulling element 110 to be differentiated from the twisted pair conductors. Using a twisted pair conductor (e.g., a copper conductor) to perform tracing can interfere with the primary conductor function of transmitting a data signal and/or power. These concerns are alleviated as a result of utilizing a pulling element 110 (or a magnet wire or other additional wire) as a tracer wire.

In other embodiments, a pulling element 110 may be formed from one or more other materials, such as dielectric and/or semi-conductive materials. Examples of suitable dielectric materials that may be utilized include, but are not limited to, fiber reinforced plastic (“FRP”), glass reinforced plastic (“GRP”), aramid materials, basalt fibers, and/or other dielectric or non-conductive materials. Examples of suitable semi-conductive materials that may be utilized include, but are not limited to, carbon fiber, graphene, etc. In certain embodiments, a dielectric or semi-conductive material may have an elastic modulus higher than that of the electrically conductive material used in the twisted pair conductors (e.g., copper, etc.).

Regardless of the material(s) utilized to form a pulling element 110, the pulling element 110 may have any suitable elastic modulus, such as any suitable Young's modulus. In certain embodiments, a pulling element 110 may have an elastic modulus greater than that of the electrically conductive material (e.g., copper, etc.) utilized to form the conductors of the twisted pairs 105A-D. In other words, the electrically conductive material utilized to form the conductors (e.g., conductors 120A, 120B, etc.) of the twisted pairs 105A-D may have a first elastic modulus, and the pulling element 110 may have a second elastic modulus greater than the first elastic modulus. In this regard, the pulling element 110 may primarily bear the tensile load associated with pulling the cable 100. For example, annealed copper typically has an elastic modulus between approximately 110 and approximately 125 GPa. In certain embodiments, a pulling element 110 may have an elastic modulus greater than approximately 125 GPa. In various embodiments, a pulling element 110 may have an elastic modulus greater than approximately 125, 130, 140, 150, 160, 175, 180, 190, 200, 210, 225, 240, 250, 275, or 300 GPa, or an elastic modulus included in a range between any two of the above values.

In other embodiments, the pulling element 110 may have an elastic modulus lower than that of the material used to form the conductors of the twisted pairs 105A-D while permitting the cable 100 to withstand increased pulling loads. For example, aramid or glass fibers may have an elastic modulus lower than that of the conductors. However, a plurality of these fibers may be tightly packed between and/or around the twisted pairs 105A-D (e.g., in the interstices between the pairs 105A-D and/or around outer circumference of the pairs 105A-D) to permit greater pulling loads to be imparted on the cable 100 without damaging the twisted pairs 105A-D.

A pulling element 110 may also be formed with a wide variety of suitable dimensions, such as any suitable gauge or cross-sectional area. In certain embodiments, a pulling element 110 may be formed with a 28 AWG, 27 AWG, 26 AWG, 25 AWG, 24 AWG, 23 AWG, 22 AWG, 21 AWG, or 20 AWG diameter, a diameter included in a range between any two of the above values, or a diameter included in a range bounded on a minimum or maximum end by one of the above values. For example, a pulling element 110 may be formed as a 26 AWG or larger pulling element, such as a 26 AWG or larger steel pulling element. In other embodiments, a pulling element may have a cross-sectional area of approximately 0.050, 0.060, 0.070, 0.080, 0.100, 0.115, 0.125, 0.130, 0.160, 0.200, 0.250, 0.325, 0.400, or 0.500 mm², a cross-sectional area included in a range between any two of the above values, or a diameter included in a range bounded on a minimum or maximum end by one of the above values. For example, a steel pulling element may have a cross-sectional area of at least 0.115 mm².

Additionally, in certain embodiments, a pulling element 110 may be formed from a single longitudinally extending component. For example, a single wire or other component may be utilized to form a pulling element. The cable 100 of FIG. 1 illustrates an example pulling element 110 formed from a single component. Other example pulling elements formed from a single component are illustrated in FIGS. 2, 4, 5, 6, 7, and 8. In other embodiments, a pulling element 110 may be formed from a plurality of components that are stranded, twisted together, or otherwise combined together along a longitudinal length. FIG. 3 illustrates an example cable in which a pulling element is formed from a plurality of components. In certain example embodiments incorporating metallic pulling elements, a pulling element 110 may be formed from a solid metallic material or with a plurality of metallic strands. In the event that a pulling element 110 includes a plurality of components, any suitable number of components may be incorporated into the pulling element 110, and each component may have any suitable dimensions (e.g., diameter, cross-sectional area, etc.). Additionally, in certain embodiments, each of the plurality of components may have similar constructions (e.g., materials, dimensions, etc.). In other embodiments, at least two of the plurality of components may have different constructions (e.g., formed from different materials, formed with different dimensions, etc.). For example, a stranded pulling element 110 may be formed from strands of at least two different metallic materials, may be formed from strands of metallic and other materials (e.g., dielectric materials, semi-conductive materials, etc.), and/or may be formed from strands of two different non-metallic materials. Other suitable constructions may be utilized as desired.

In certain embodiments, a pulling element 110 may be formed as a bare, uninsulated, or uncoated pulling element. For example, a pulling element 110 may be formed as a bare metallic or uncoated non-metallic pulling element. As desired, a bare metallic pulling element may be used as a drain wire in the cable 100. In other embodiments, suitable insulation or a suitable coating may be formed around a pulling element 110. FIG. 2 illustrates an example pulling element in which insulation or a dielectric coating is formed around a metallic component. A wide variety of suitable materials may be utilized as desired to form insulation around a metallic pulling element, such as any of the materials discussed in greater detail above with respect to twisted pair insulation 125 or jacket materials. Insulation may be formed from a single or from multiple layers, and each insulation layer may have any suitable thickness. Additionally, in certain embodiments, an insulated pulling element 110 may optionally be used to transmit data and/or power signals along the cable 100.

Similarly, one or more suitable coating layers may be formed around a non-metallic pulling element. Examples of suitable materials that may be utilized to form a coating around a pulling element include, but are not limited to, polyethylene (e.g., medium density polyethylene, etc.), polypropylene, one or more other polymeric materials (e.g., such as any of the materials described above with reference to the twisted pair insulation 125 or the jacket, etc.), one or more thermoplastic materials, one or more elastomeric materials, an ethylene-acrylic acid (“EAA”) copolymer, ethyl vinyl acetate (“EVA”), etc.

Additionally, any number of suitable pulling elements may be incorporated into a cable 100 as desired in various embodiments. As shown in FIG. 1, in certain embodiments, a single pulling element 110 may be incorporated into the cable. In other embodiments, a plurality (e.g., two, three, four, etc.) of pulling elements may be incorporated into a cable 100. FIGS. 6-8, which are described in greater detail below, illustrate a few example cables that include a plurality of pulling elements. In the event that a plurality of pulling elements are utilized, in certain embodiments, each of the pulling elements may have similar constructions. In other embodiments, at least two pulling elements may be formed with different constructions. For example, at least two pulling elements may be formed from different materials (e.g., a first pulling element formed from a metallic material and a second pulling element formed from a dielectric material, etc.). As another example, at least two pulling elements may be formed with different dimensions.

One or more pulling elements 110 may also be positioned at a wide variety of suitable locations within a cable 100. In certain embodiments, one or more pulling elements 110 may be positioned between the twisted pairs 105A-D and the cable jacket 115. For example, as shown in FIG. 1, one or more pulling elements 110 may be positioned or situated around an outer periphery of the twisted pairs 105A-D. In the event that a cable includes an outer shield layer, one or more pulling elements 110 may be positioned inside the shield layer (as shown in FIG. 2) or outside the shield layer (as shown in FIG. 3). In other embodiments, as shown in FIG. 4, one or more pulling elements 110 may be positioned between the plurality of twisted pairs 105A-D. For example, a pulling element 110 may longitudinally extend along a cross-sectional centerline of a cable 100. In yet other embodiments, as shown in FIG. 5, one or more pulling elements 110 may be incorporated into or positioned within a cable separator. For example, a pulling element 110 may be positioned within a longitudinally extending cavity or pocket of a separator. In yet other embodiments, as shown in FIG. 8, one or more pulling elements 110 may be embedded within the cable jacket 115. As desired in other embodiments, a plurality of pulling elements may be positioned at different locations within a cable 100. For example, a first pulling element may be positioned between the plurality of twisted pairs 105A-D while a second pulling element is positioned outside an outer periphery of the twisted pairs 105A-D. A wide variety of other suitable configurations of pulling elements may be utilized as desired.

In certain embodiments, the one or more pulling elements 110 incorporated into a cable 100 may extend in a longitudinally direction parallel to the plurality of twisted pairs 105A-D. In other words, the one or more pulling elements 110 may not be twisted or stranded with the plurality of twisted pairs 105A-D. As a result of extending in a longitudinal direction parallel to the twisted pairs 105A-D, the load borne by the pulling elements 110 may extend along the tensile pulling direction, thereby reducing the strain placed on the twisted pairs 105A-D. Additionally, a longitudinally extending cable element, such as a pulling element 110, may experience greater overall elongation than the twisted pairs 105A-D. Given the higher elastic modulus of the pulling element, this may assist in reducing the strain placed on the twisted pairs 105A-D.

In certain embodiments, incorporation of one or more relatively small pulling elements 110 may result in limited or approximately no change in the outer diameter size of a cable. In other words, a cable 100 may incorporate one or more pulling elements 110 while maintaining a relatively small outer diameter. In certain embodiments, a cable 100 having four twisted pairs 105A-D may have an outer diameter of approximately 10 mm or less. In various embodiments, the cable 100 may have an outer diameter of less than approximately 5, 6, 7, 8, 9, or 10, or an outer diameter included in a range between any two of the above values.

As a result of incorporating one or more pulling elements 110 into a cable 100, the cable 100 may withstand increased pulling forces or pulling loads. The ability to withstand increased pulling loads may facilitate installation of the cable 100 at longer longitudinal lengths or with longer single cable runs. In certain embodiments, the cable 100 may be installed at lengths longer than the 100 m established by industry standards. For example, the cable 100 may be installed at maximum lengths of up to 150, 200, 250, 300, or 350 m, at maximum lengths included in a range between any two of the above values, or at maximum lengths included in a range bounded on a minimum end by one of the above values (e.g., at least 200 m, at least 300 m, etc.).

As desired in various embodiments, a wide variety of other materials may be incorporated into the cable 100. In certain embodiments, the cable 100 may additionally include one or more suitable rip cords and/or drain wires. As desired, a cable 100 may also include a wide variety of water blocking or water swellable materials, insulating materials, dielectric materials, flame retardants, flame suppressants or extinguishants, gels, and/or other materials. The cable 100 illustrated in FIG. 1 is provided by way of example only. Embodiments of the disclosure contemplate a wide variety of other cables and cable constructions. These other cables may include more or less components than the cable 100 illustrated in FIG. 1. Additionally, certain components may have different dimensions and/or materials than the components illustrated in FIG. 1.

FIG. 2 illustrates a cross-sectional view of a second example cable 200 with an additional wire, such as a magnet wire or integrated pulling element. As shown, the cable 200 may include a plurality of twisted pairs 205A-D of individually insulated conductors, at least one additional wire 210, and a jacket 215 formed around the twisted pairs 205A-D and the additional wire 210. Each of these components may be similar to those discussed above with reference to the cable 100 of FIG. 1. Additionally, the cable 200 may include an overall shield 220 formed around the plurality of twisted pairs 205A-D. The overall shield 220 may be formed with a wide variety of suitable constructions, such as any of the constructions discussed above with reference to FIG. 1.

In contrast to the cable 100 illustrated in FIG. 1, the additional wire 210 incorporated into the cable 200 of FIG. 2 is illustrated as including insulation or a coating around a central component. For example, the additional wire 210 may be a magnet wire that includes thermoset enamel insulation. As another example, the additional wire 210 may be a pulling element that includes dielectric insulation formed around a central metallic component (e.g., a steel component, etc.). As described in greater detail above with reference to FIG. 1, a wide variety of suitable materials may be utilized as desired to form insulation or a coating on a magnet wire or a pulling element. Additionally, the additional wire 210 is illustrated as being positioned within a cable core and inside an overall shield 220. In other words, the additional wire 210 may be positioned between the shield 220 and the twisted pairs 205A-D. In certain embodiments, the additional wire 210 may extend parallel to twisted pairs 205A-D without being twisted or stranded with the pairs 205A-D. In other embodiments, the additional wire 210 may be twisted or stranded with the pairs 205A-D. The additional wire 210 may also be positioned at a wide variety of other suitable locations in other embodiments.

FIG. 3 illustrates a cross-sectional view of a third example cable 300 with an additional wire, such as a magnet wire or integrated pulling element. As shown, the cable 300 may include a plurality of twisted pairs 305A-D of individually insulated conductors, at least one additional wire 310, and a jacket 315 formed around the twisted pairs 305A-D and the additional wire 310. Each of these components may be similar to those discussed above with reference to the cable 100 of FIG. 1. Additionally, the cable 300 may include an overall shield 320 formed around the plurality of twisted pairs 305A-D. The overall shield 320 may be formed with a wide variety of suitable constructions, such as any of the constructions discussed above with reference to FIG. 1.

In contrast to the cable 100 illustrated in FIG. 1, the additional wire 310 incorporated into the cable 300 of FIG. 3 is illustrated as including a plurality of components that are parallel to one another or that are stranded or twisted together. For example, the additional wire 310 may include a plurality of magnet wires that are parallel to one another, stranded together, or configured as a continuously transposed conductor. As another example, the additional wire 310 may include a pulling element formed from a plurality of metallic strands (e.g., steel strands, etc.). In other embodiments, a pulling element may be formed from a plurality of dielectric or semi-conductive strands. In yet other embodiments, a pulling element may include a plurality of strands with at least two strands having different constructions (e.g., a combination of metallic and non-metallic strands, etc.). Regardless of the materials used to form a stranded additional wire (e.g., a magnet wire, a pulling element, etc.), any suitable number of strands may be utilized as desired in various embodiments. Additionally, the strands may be formed with a wide variety of suitable dimensions (e.g., diameters, cross-sectional areas, etc.). Forming an additional wire 310 from a plurality of strands may increase the flexibility of the additional wire 310 and the overall cable 300.

Additionally, the additional wire 310 is illustrated as being positioned within a cable core and outside an overall shield 320. In other words, the additional wire 310 may be positioned between the shield 320 and the jacket 310, and the additional wire 310 may extend parallel to twisted pairs 305A-D without being twisted or stranded with the pairs 305A-D. The additional wire 310 may be positioned at a wide variety of other suitable locations in other embodiments.

FIG. 4 illustrates a cross-sectional view of a fourth example cable 400 with an additional wire, such as a magnet wire or integrated pulling element. As shown, the cable 400 may include a plurality of twisted pairs 405A-D of individually insulated conductors, at least one additional wire 410, and a jacket 415 formed around the twisted pairs 405A-D and the additional wire 410. Each of these components may be similar to those discussed above with reference to the cable 100 of FIG. 1. In contrast to the cable 100 illustrated in FIG. 1, the additional wire 410 incorporated into the cable 400 of FIG. 4 is not illustrated as being formed from metallic material. Instead, the illustrated additional wire 410 may constitute a pulling element formed from a wide variety of other suitable materials, such as dielectric materials or semi-conductive materials. Alternatively, an additional wire 410 (e.g., a magnet wire, an integrated pulling element, etc.) may be formed from metallic materials in other embodiments. Example materials that are suitable for forming the additional wire 410 are described in greater detail above with reference to FIG. 1.

Additionally, the additional wire 410 is illustrated as being positioned within a cable core between the plurality of twisted pairs 405A-D. In certain embodiments, while the twisted pairs 405A-D may be twisted around the additional wire 410, the additional wire may longitudinally extend approximately along a cross-sectional center line of the cable 400. As a result, the additional wire 410 may extend parallel to the twisted pairs 405A-D. For example, in the event that the additional wire is a pulling element, the pulling element may be permitted to bare a pulling load imparted on the cable 400. In other embodiments, the additional wire 410 may be positioned between the twisted pairs 405A-D, and the additional wire 410 may be twisted or stranded with the twisted pairs 405A-D.

FIG. 5 illustrates a cross-sectional view of a fifth example cable 500 with an additional wire. As shown, the cable 500 may include a plurality of twisted pairs 505A-D of individually insulated conductors, at least one additional wire 510 (e.g., a magnet wire, an integrated pulling element, etc.), and a jacket 515 formed around the twisted pairs 505A-D and the additional wire 410. Each of these components may be similar to those discussed above with reference to the cable 100 of FIG. 1. The cable 500 may also include an overall shield 520 formed around the plurality of twisted pairs 505A-D. The overall shield 520 may be formed with a wide variety of suitable constructions, such as any of the constructions discussed above with reference to FIG. 1. Additionally, the cable 500 may include a cross-filler separator 525 positioned between the plurality of twisted pairs 505A-D. The cross-filler separator 525 may be similar to that described above with reference to FIG. 1.

In contrast to the cable 100 illustrated in FIG. 1, the additional wire 510 incorporated into the cable 500 of FIG. 5 is illustrated as being positioned between the plurality of twisted pairs 505A-D. In particular, the additional wire 510 may be embedded or positioned within the separator 525. For example, the additional wire 510 may be positioned within a longitudinally extending cavity or channel formed through the separator 525. In certain embodiments, a separator 525 may be extruded around the additional wire 510 such that the additional wire 515 is positioned within a cavity. In other embodiments, the separator 525 may be extruded or otherwise formed to include a cavity into which the additional wire 515 may be subsequently positioned. In yet other embodiments, the separator 525 may be formed from one or more tapes that are folded or otherwise manipulated around the additional wire 515 such that the additional wire 515 is positioned within a cavity of the separator 525. Additionally, in certain embodiments, the additional wire 510 may be free to move, slide, or rotate within the cavity. For example, the cavity may be formed with an inner diameter that is larger than that of the additional wire's 510 outer diameter. As another example, the additional wire 510 may not be adhered or otherwise bonded to the separator 525.

In certain embodiments, the additional wire 510 may longitudinally extend along a cross-sectional centerline of the plurality of twisted pairs 505A-D and/or the cable 500. Although the twisted pairs 505A-D may be helically twisted with the separator 525, the additional wire 510 may longitudinally extend parallel to the twisted pairs 505A-D. In the event that the additional wire constitutes a pulling element, the pulling element may be permitted to bare a pulling load imparted on the cable 500. Additionally, if the additional wire 510 is free to move within a cavity of the separator 525, a twist will not be imparted on the additional wire 510 when the separator 525 is twisted with the pairs 505A-D. In other embodiments, the additional wire 510 may be positioned within the separator 525 (e.g., positioned within a cavity that is not centrally located, etc.) such that the additional wire 510 is twisted or stranded with the twisted pairs 505A-D as the pairs 505A-D are stranded with the separator 525.

FIG. 6 illustrates a cross-sectional view of a sixth example cable 600 with one or more additional wires, such as one or more magnet wires and/or integrated pulling elements. As shown, the cable 600 may include a plurality of twisted pairs 605A-D of individually insulated conductors, at least one additional wire 610A, 610B, and a jacket 615 formed around the twisted pairs 605A-D and the additional wire(s) 610A, 610B. Each of these components may be similar to those discussed above with reference to the cable 100 of FIG. 1. In contrast to the cable 100 illustrated in FIG. 1, the cable 600 of FIG. 6 is illustrated as including a plurality of additional wires 610A, 610B. Although two additional wires 610A, 610B are illustrated in FIG. 6, any suitable number of additional wires may be incorporated into the cable 600 as desired in various embodiments. Additionally, the additional wires 610A, 610B may each be formed with a wide variety of suitable constructions. In certain embodiments, each of the additional wires 610A, 610B may be formed with similar constructions, such as the illustrated magnet wires or metallic pulling elements having similar dimensions. In other embodiments, the additional wires 610A, 610B may be formed with different constructions, such as from different materials.

Additionally, a plurality of additional wires 610A, 610B may be positioned at a wide variety of suitable locations within the cable 600. For example, the plurality of additional wires 610A, 610B may be positioned within a cable core. As shown, the additional wires 610A, 610B may be positioned on opposite sides of the cable core around an outer periphery of the twisted pairs 605A-D. In other embodiments, a first additional wire may be positioned between the plurality of twisted pairs 605A-D, and one or more second additional wires may be positioned between the twisted pairs 605A-D and the jacket 615. A wide variety of other suitable orientations and configurations may be utilized as desired in other embodiments.

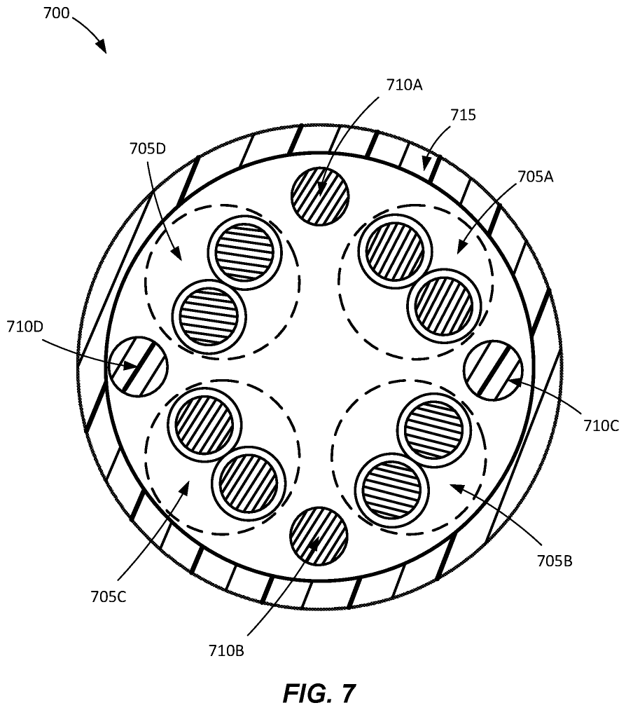

FIG. 7 illustrates a cross-sectional view of a seventh example cable 700 with one or more additional wires, such as one or more magnet wires and/or integrated pulling elements. As shown, the cable 700 may include a plurality of twisted pairs 705A-D of individually insulated conductors, at least one additional wire 710A-D, and a jacket 715 formed around the twisted pairs 705A-D and the additional wire(s) 710A-D. Each of these components may be similar to those discussed above with reference to the cable 100 of FIG. 1. In contrast to the cable 100 illustrated in FIG. 1, the cable 700 of FIG. 7 is illustrated as including a plurality of additional wires 710A-D. In particular, the cable 700 is illustrated as including four additional wires 710A-D. Any other suitable number of additional wires may be utilized as desired in other embodiments. Additionally, the additional wires 710A-D are illustrated as being formed with different constructions. For example, a first group of pulling elements 710A, 710B may be formed as metallic pulling elements, and a second group of pulling elements 710C, 710D may be formed from other materials (e.g., dielectric materials, semi-conductive materials, etc.). In other embodiments, a plurality of magnet wires may be formed with different types of insulation layers. In yet other embodiments, a combination of magnet wires and integrated pulling elements may be incorporated into a cable 700. Example materials for forming magnet wires and/or pulling elements are described in greater detail above with reference to FIG. 1. Additionally, each of the additional wires 710A-D may be formed with any suitable dimensions. In certain embodiments, the incorporation of different types (e.g., metallic, dielectric, and/or semi-conductive) of pulling elements into a cable and/or the mixing of different types of pulling elements may be utilized to achieve a desired cost and performance balance. For example, mixing pulling elements may permit a cable to withstand a desired pulling load while meeting cost considerations.

Additionally, the plurality of additional wires 710A-D may be positioned at a wide variety of suitable locations within the cable 700. For example, the plurality of additional wires 710A-D may be positioned within a cable core. As shown, two metallic pulling elements 710A, 710B may be positioned on opposite sides of the cable core around an outer periphery of the twisted pairs 705A-D. Similarly, two non-metallic pulling elements 710C, 710D may be positioned on opposite sides of the cable core around an outer periphery of the twisted pairs 705A-D. The metallic pulling elements 710A, 710B and the non-metallic pulling elements 710C, 710D may be offset from one another. In other embodiments, a first pulling element or other additional wire may be positioned between the plurality of twisted pairs 705A-D, and one or more second pulling elements or other additional wires may be positioned between the twisted pairs 705A-D and the jacket 715. A wide variety of other suitable orientations and configurations may be utilized as desired in other embodiments.

FIG. 8 illustrates a cross-sectional view of an eighth example cable 800 with one or more additional wires, such as one or more magnet wires and/or integrated pulling elements. As shown, the cable 800 may include a plurality of twisted pairs 805A-D of individually insulated conductors, at least one additional wire 810A, 810B, and a jacket 815 formed around the twisted pairs 805A-D and the additional wire(s) 810A, 810B. Each of these components may be similar to those discussed above with reference to the cable 100 of FIG. 1. In contrast to the cable 100 illustrated in FIG. 1, the cable 800 of FIG. 8 is illustrated as including a plurality of additional wires 810A, 810B embedded within the cable jacket 815. Any suitable number of additional wires 810A, 810B may be embedded within the jacket 815 as desired in various embodiments. Each of the additional wires 810A, 810B may also be formed with a wide variety of suitable constructions, such as any of the constructions discussed above with reference to FIG. 1. Additionally, the additional wires 810A, 810B may be positioned with a wide variety of suitable configurations. For example, the additional wires 810A, 810B may be positioned on opposite sides of the cable core. In other embodiments, one or more first additional wires may be embedded within the cable jacket 815 and one or more second additional wires may be positioned within the cable core.

As desired in various embodiments, a wide variety of other materials may be incorporated into any of the cables illustrated in FIGS. 2-8. In certain embodiments, a cable may additionally include a separator, any number of shields, one or more suitable rip cords, and/or one or more drain wires. As desired, a cable may also include a wide variety of water blocking or water swellable materials, insulating materials, dielectric materials, flame retardants, flame suppressants or extinguishants, gels, and/or other materials. The cables illustrated in FIGS. 2-8 are provided by way of example only. Embodiments of the disclosure contemplate a wide variety of other cables and cable constructions. These other cables may include more or less components than the cable illustrated in FIGS. 2-8.

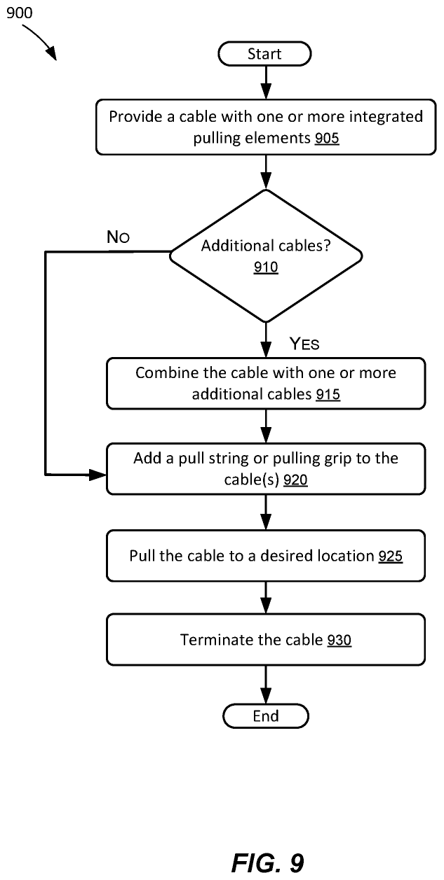

FIG. 9 is a flowchart of an example method 900 for installing a cable incorporating one or more pulling elements as additional wires, according to an illustrative embodiment of the disclosure. The method 900 may be utilized to install a wide variety of cables that include pulling elements, such as any of the cables described above with reference to FIGS. 1-8. The method 900 may begin at block 905.

At block 905, a twisted pair cable having one or more integrated pulling elements may be provided. In certain embodiments, the cable may be provided on a reel, box, coil, or other suitable packaging that permits the cable to be pulled and installed by a technician. At block 910, a determination may be made as to whether any additional cables will be pulled or run in conjunction with the provided cable. If it is determined at block 910 that no additional cables will be pulled with the cable, then operation may continue at block 920 below. If, however, it is determined at block 910 that one or more additional cables will be pulled with the cable, then operations may continue at block 915. At block 915, the cable may be combined with one or more additional cables. For example, the cable and the additional cable(s) may be taped, tied, or otherwise joined together. As desired, the cables may be staggered as they are joined together in order to reduce the chances that the cables will snag or catch during pulling. Operations may then continue at block 920.

At block 920, a pull string, Kellems grip, or other suitable pulling device may be added to the cable(s). The pulling device (and tape if multiple cables are joined together) may compress the components of the cable(s) together, thereby essentially coupling the cable conductors and cable pulling elements together. When coupled together, the components of the cable may be pulled at the same rate such that they experience the same elongation. Given the twists imparted on the twisted pairs, the pairs will elongate less than untwisted or straight components, such as the pulling element(s). Additionally, due to the pulling element(s) having a higher elastic modulus than the other cable components, the pulling element(s) may bear the pulling load or a suitable portion of the pulling load to prevent damage or untwisting of the pairs. For example, pulling forces imparted on the cable may be primarily borne by the integrated pulling element(s).

At block 925, the cable may be pulled to a desired termination location. According to an aspect of the disclosure, the integrated pulling elements may permit a pulling force of greater than 110 N to be imparted on the cable. For example, a pulling force of up to 330 N may be imparted on the cable. Additionally, the ability to withstand a higher pulling force may permit the cable to be installed at lengths or with runs exceeding 100 m. For example, the cable may be installed at a length of up to approximately 300 m. Once the cable has been pulled to a desired location, the cable may be terminated at block 930. For example, a technician may terminate the cable utilizing a suitable RJ-45 or other appropriate connector. Additionally, the cable may be connected to a suitable device, such as a PoE device (e.g., a wireless access point, a video camera, etc.), an Ethernet-enabled device, etc. In certain embodiments, the cable may be connected directly to a device. In other embodiments, one o more suitable patch cords may be utilized to connect the cable to a device. Operations may then terminate following block 930.

As desired, the method 900 may include more or less operations than those illustrated in FIG. 9. Additionally, as desired, certain operations of the method 900 may be formed in parallel or in a different order than that set forth in FIG. 9. Indeed, the method 900 is provided by way of non-limiting example only.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cable, comprising:
four twisted pairs of individually insulated wires, the respective insulation for the individually insulated wires comprising first polymeric material;
an additional wire comprising a conductor and at least one layer of enamel insulation material formed around the conductor, the enamel insulation comprising second polymeric material different from the first polymeric material and the second polymeric material comprising one or more thermoset polymeric materials; and
a jacket formed around the four twisted pairs and the at least one additional wire,
wherein the cable has an outer diameter of less than 10 mm.

2. The cable of claim 1, wherein the additional wire longitudinally extends parallel to the four twisted pairs.

3. The cable of claim 1, wherein the additional wire is helically stranded with the four twisted pairs.

4. The cable of claim 1, wherein the conductor comprises one of copper or aluminum.

5. The cable of claim 1, wherein the additional wire has a cross-sectional area greater than or equal to 0.0160 mm².

6. (canceled)

7. The cable of claim 1, wherein the enamel insulation comprises at least one of polyimide, polyamideimide, polyester, polyamide, amideimide, polyesterimide, polysulfone, polyphenylenesulfone, polysulfide, or polyphenylenesulfide.

8. The cable of claim 1, wherein the cable has a longitudinal length greater than 100 m.

9. A cable, comprising:
a plurality of twisted pairs of individually insulated conductors, the respective insulation for the individually insulated conductors comprising first polymeric material;
a longitudinally extending magnet wire comprising a conductive element and enamel insulation formed around the conductive element, the enamel insulation comprising second polymeric material different from the first polymeric material and the second polymeric material comprising one or more thermoset polymeric materials; and
a jacket formed around the plurality of twisted pairs and the magnet wire.

10. The cable of claim 9, wherein the magnet wire longitudinally extends parallel to the plurality of twisted pairs.

11. The cable of claim 9, wherein the magnet wire is helically stranded with the plurality of twisted pairs.

12. The cable of claim 9, wherein the magnet wire has a cross-sectional area greater than or equal to 0.0160 mm².

13. (canceled)

14. The cable of claim 9, wherein the enamel insulation comprises at least one of polyimide, polyamideimide, polyester, polyamide, amideimide, polyesterimide, polysulfone, polyphenylenesulfone, polysulfide, or polyphenylenesulfide.

15. The cable of claim 9, wherein the cable has a longitudinal length greater than 100 m.

16. The cable of claim 9, wherein the cable has an outer diameter of less than 10 mm.

17. A cable, comprising:
a plurality of twisted pairs of individually insulated wires, the respective insulation for the individually insulated wires comprising first polymeric material;
a longitudinally extending magnet wire comprising a conductor and enamel insulation formed around the conductor, the enamel insulation comprising second polymeric material different from the first polymeric material and the second polymeric material comprising one or more thermoset polymeric materials; and
a jacket formed around the plurality of twisted pairs and the magnet wire,
wherein the cable has a longitudinal length greater than 100 m and an outer diameter of less than 10 mm.

18. The cable of claim 17, wherein the magnet wire longitudinally extends parallel to the plurality of twisted pairs.

19. The cable of claim 17, wherein the magnet wire has a cross-sectional area greater than or equal to 0.0160 mm².

20. The cable of claim 17, wherein the enamel insulation comprises at least one of polyimide, polyamideimide, polyester, polyamide, amideimide, polyesterimide, polysulfone, polyphenylenesulfone, polysulfide, or polyphenylenesulfide.

21. The cable of claim 17, wherein the magnet wire is helically stranded with the plurality of twisted pairs.

22. The cable of claim 17, wherein the conductor comprises one of copper or aluminum.
